(19) United States
(12) Patent Application Publication
(10) Pub. No.: US 2026/0264177 A1
(43) Pub. Date: Sep. 10, 2026

(54) OVERHEAD JOIST ASSEMBLY SYSTEMS AND METHODS

(71) Applicant: NUCOR CORPORATION, Charlotte, NC (US)

(72) Inventors: Derek T. Kowalski, Norfolk, NE (US); Ory N. Stephens, Chickamauga, GA (US); Mitchel E. Stipek, Battle Creek, NE (US)

(73) Assignee: NUCOR CORPORATION, Charlotte, NC (US)

(21) Appl. No.: 19/555,034

(22) Filed: Mar. 3, 2026

Related U.S. Application Data
(60) Provisional application No. 63/769,360, filed on Mar. 10, 2025.

(51) Int. Cl. B23K 31/02; B23K 37/04; B23K 101/24; B23K 101/28

(52) U.S. Cl. CPC B23K 31/022; B23K 37/0461; B23K 2101/24; B23K 2101/28

(57) ABSTRACT

A joist assembly system that provides dynamic retrieval of components, dynamic and precise positioning of retrieved components, assembly of the components to form a joist, and delivery of the assembled joist. The joist assembly system has a plurality of material handling systems, a plurality of welding systems, and a rigging table system. The material handling systems position two or more webs with respect to the first chord and the second chord at the rigging table system. Subsequently, the plurality of welding systems weld the two or more webs to the upper chord and the lower chord to form the joist. The material handling systems and the welding systems are configured to move longitudinally and/or laterally with respect to the rigging table system using upper and/or lower transport systems. The upper transport system may be supported by ceiling supports in the floor and/or roof above the rigging table system.

### CROSS REFERENCE AND PRIORITY CLAIM UNDER 35 U.S.C. §119

This application claims priority to U.S. Provisional Application No. 63/769,360 entitled “Overhead Joist Assembly Systems and Methods” filed on Mar. 10, 2025, which is assigned to the assignee hereof and the entirety of which is incorporated by reference herein.

### FIELD

The present disclosure relates generally to joist assembly systems and methods of forming joists using the joist systems. More specifically, the present disclosure relates to a joist system with robots that deliver joist members to a table and weld the joist members together to form the joists.

### BACKGROUND

Tables used to assemble structures, such as joists (otherwise described as trusses) have typically incorporated jigs or supports that hold the chord members and web members together in the desired configuration, which allows a worker to weld the chord members and web members together in the desired configuration. Typically, the members may be delivered to or near the table through the use of a machine, such as through a forklift, conveyor belt, rollers, or the like.

### SUMMARY OF THE EMBODIMENTS OF THE INVENTION

The present invention relates generally to a joist assembly system that is structured for dynamic retrieval of components, dynamic and precise positioning and location of retrieved components, assembly of the components to form a joist, and delivery of the assembled joist. Specifically, the joist assembly system comprises a plurality of material handling systems, a plurality of welding systems, and a rigging table system. Typically, the material handling systems are structured to load and position the components, such as the chords and the webs onto the rigging table system. The rigging table system in turn supports the chords and/or the webs. Subsequently, the plurality of welding systems may weld the webs to the chords to form the joist.

In particular embodiments, the support structure may comprise of vertical supports coupled to the floor, supports that form a wall, overhead supports (e.g., supports for floor or roof located above the rigging table system, or the like, or combinations thereof). The joist assembly system may further comprise an overhead transport system coupled to the support structure, wherein the plurality of material handling systems and/or the plurality of welding systems are coupled to the overhead transport assembly at least partially above the rigging table system, and wherein the overhead transport system transports the plurality of material handling systems and/or the plurality of welding systems longitudinally and laterally with respect to the rigging table system to assemble the joists.

One embodiment of the invention comprises a joist assembly system. The joist assembly system comprises a support structure, a plurality of material handling systems configured move one or more chords or one or more webs of a joist, a plurality of welding systems configured to weld the one or more webs to the one or more chords, a rigging table system configured to support at least a portion of the joists during assembly, and an overhead transport system coupled to the support structure. The plurality of material handling systems or the plurality of welding systems are coupled to the overhead transport system at least partially above the rigging table system, and wherein the overhead transport system transports the plurality of material handling systems or the plurality of welding systems longitudinally and laterally with respect to the rigging table system. The joist assembly system further comprises a controller system comprising one or more memory components storing computer-readable code, and one or more processing components coupled to the one or more memory components. When executed the computer-readable code is configured to cause the one or more processing components to communicate with the plurality of material handling systems to position the one or more webs with respect to the one or more chords and communicate with the plurality of welding systems to weld the one or more webs to the one or more chords.

In further accord with embodiments, the overhead transport system comprises one or more upper transport assemblies comprising. The one or more upper transport assemblies comprise one or more upper longitudinal tracks, one or more upper longitudinal carriages coupled to the one or more upper longitudinal tracks, and one or more upper longitudinal drives configured to move the one or more upper longitudinal carriages with respect to the one or more upper longitudinal tracks. The one or more upper longitudinal carriages move with respect to the one or more upper longitudinal tracks.

In other embodiments, the one or more upper transport assemblies comprise one or more upper lateral tracks coupled to the one or more upper longitudinal carriages, one or more upper lateral carriages coupled to the one or more upper lateral tracks, and one or more upper lateral drives configured to move the one or more upper lateral carriages with respect to the upper lateral tracks.

In still other embodiments, the plurality of material handling systems are coupled to the overhead transport system.

In yet other embodiments, the plurality of welding systems are coupled to the overhead transport system.

In other embodiments, two or more of the plurality of material handling system or two or more of the plurality of welding systems are coupled to the overhead transport system.

In further accord with embodiments, the joist assembly system of claim further comprises a lower transport system. The lower transport system comprises one or more lower transport assemblies comprising one or more lower tracks, one or more lower carriages coupled to the one or more lower tracks, and one or more lower drives configured to move the one or more lower carriages with respect to the one or more lower tracks. The one or more lower carriages move with respect to the one or more lower tracks, and the other of the plurality of material handling system or the plurality of welding systems are coupled to the lower transport system adjacent the rigging table system.

In other embodiments, the support structure comprises an overhead support located above the rigging table system.

In still other embodiments, the overhead support comprises one or more vertical supports extending from a floor adjacent the rigging table system to a height above the rigging table system, wherein the overhead transport system is coupled to an upper portion of the one or more vertical supports.

In yet other embodiments, the overhead support comprises one or more ceiling supports coupled to one or more building supports, wherein the overhead transport system is coupled to the one or more ceiling supports.

In other embodiments, the plurality of material handling systems comprise a plurality of web material handling systems coupled to the overhead transport system. The plurality of web material handling systems are configured to pick the one or more webs and hold the one or more webs in place to restrict movement of the one or more webs while the plurality of welding systems at least partially weld the one or more webs to the one or more chords.

In further accord, the plurality of material handling systems comprise a material handling robotic arm and a material handling effector.

In other embodiments, the plurality of welding systems comprise a plurality of first welding systems adjacent a first side of the rigging table system configured to weld the one or more webs to an upper chord. The plurality of welding systems further comprise a plurality of second welding systems adjacent a second side of the rigging table system configured to weld the one or more webs to a lower chord.

In still other embodiments, the plurality of welding systems comprise a welding robotic arm and a weld head.

In yet other embodiments, the joist assembly system further comprises a material supply station comprising a chord supply system configured to supply the one or more chords to an entry end of the rigging table system.

In other embodiments, the rigging table system comprises a discharging system configured to move an assembled joist away from the rigging table system.

In further accord with embodiments, the discharging system comprises a plurality of rollers configured to extend from a rigging table and retract within the rigging table, and wherein plurality of rollers rotate. The discharging system is configured to discharge an assembled joist such that the plurality of rollers are extended to disengage the assembled joist from the rigging table system and the plurality of rollers rotate to move the assembled joist off of the rigging table system.

In other embodiments, the one or more chords comprise an upper chord comprising a first upper chord portion and a second upper cord portion, and a lower chord comprising a first lower chord portion and a second lower chord portion. The computer-readable code is configured to cause the one or more processing components to communicate with one or more material handling systems of the plurality of material handling systems to pick the first upper chord portion and the first lower chord portion from a material supply station and position the first upper chord portion and the first lower chord portion on the rigging table system. The two or more welding systems weld the one or more webs to the first upper chord portion and the first lower chord portion at the same time. The computer-readable code is further configured to communicate with the one or more material handling systems of the plurality of material handling systems to pick a second upper chord portion and a second lower chord portion from the material supply station and position the second upper chord portion and the second lower chord portion onto the one or more webs. The two or more welding systems weld the second upper chord portion and the second lower chord portion to the one or more webs at the same time.

Another embodiment of the invention comprises a method of assembling a joist using the joist assembly system described herein. The method comprising positioning the one or more chords at the rigging table system, picking the one or more webs using one or more of the plurality of material handling systems, positioning the one or more webs with respect to the one or more chords at the rigging table system, and welding the one or more webs to the one or more chords.

To the accomplishment the foregoing and the related ends, the one or more embodiments of the invention comprise the features hereinafter fully described and particularly pointed out in the claims. The following description and the annexed drawings set forth certain illustrative features of the one or more embodiments. These features are indicative, however, of but a few of the various ways in which the principles of various embodiments may be employed, and this description is intended to include all such embodiments and their equivalents.

### BRIEF DESCRIPTION OF THE SEVERAL VIEWS OF THE DRAWINGS

The accompanying drawings illustrate embodiments of the present disclosure, in which:

FIG. 1 is an overhead perspective view of the joist assembly system, in accordance with embodiments of the present disclosure.

FIG. 2 is a side perspective view of a portion of the joist assembly system, in accordance with embodiments of the present disclosure.

FIG. 3 is an enlarged side perspective view of a portion of the joist assembly system, in accordance with embodiments of the present disclosure.

FIG. 4 is an end perspective view of the joist assembly system, in accordance with embodiments of the present disclosure.

FIG. 5 is an enlarged end perspective view of the joist assembly system, in accordance with embodiments of the present disclosure.

FIG. 6A is an overhead perspective view of the joist assembly system, in accordance with embodiments of the present disclosure.

FIG. 6B is an enlarged overhead perspective view of the joist assembly system, in accordance with embodiments of the present disclosure.

FIG. 7A is an overhead perspective view of a material handling system and a plurality of welding systems of the joist assembly system before welding, in accordance with embodiments of the present disclosure.

FIG. 7B is an overhead perspective view of a material handling system and a plurality of welding systems of the joist assembly system during welding, in accordance with embodiments of the present disclosure.

FIG. 7C is an overhead perspective view of the welding systems and a portion of the lower transport assemblies, in accordance with embodiments of the present disclosure.

FIG. 8A is a perspective view of a portion of an upper transport assembly having a longitudinal carriage and a longitudinal track, in accordance with embodiments of the present disclosure.

FIG. 8B is a perspective view of a portion of an upper transport assembly having a lateral carriage and a lateral track, in accordance with embodiments of the present disclosure.

FIG. 9 is a perspective view of a portion of a lower transport assembly having a lower carriage and a lower track, in accordance with embodiments of the present disclosure.

FIG. 10A is a perspective view of a portion of a rigging table system with a discharging system, in accordance with embodiments of the present disclosure.

FIG. 10B is an overhead perspective view of a portion of the rigging table system with an assembled joist and discharging system, in accordance with embodiments of the present disclosure.

FIG. 10C is a perspective view a rigging table system with a partially assembled joist and discharging system, in accordance with embodiments of the present disclosure.

FIG. 11 is a schematic view of a network diagram, in accordance with embodiments of the invention.

FIG. 12 is a process flow illustrating the assembly process using the joist assembly system, in accordance with embodiments of the invention.

FIG. 13A illustrates one example joist that may be assembled using the joist assembly system, in accordance with embodiments of the invention.

FIG. 13B illustrates a portion of one example joist that may be assembled using the joist assembly system, in accordance with embodiments of the invention.

FIG. 13C illustrates a portion of one example joist having a gusset plate that may be assembled using the joist assembly system, in accordance with embodiments of the invention.

FIG. 13D illustrates a portion of one example joist with a joist seat that may be assembled using the joist assembly system, in accordance with embodiments of the invention.

### DETAILED DESCRIPTION OF EMBODIMENTS OF THE INVENTION

Embodiments of the present invention will now be described more fully hereinafter with reference to the accompanying drawings, in which some, but not all, embodiments of the invention are shown. Indeed, the invention may be embodied in many different forms and should not be construed as limited to the embodiments set forth herein; rather, these embodiments are provided so that this disclosure will satisfy applicable legal requirements. Like numbers refer to like elements throughout.

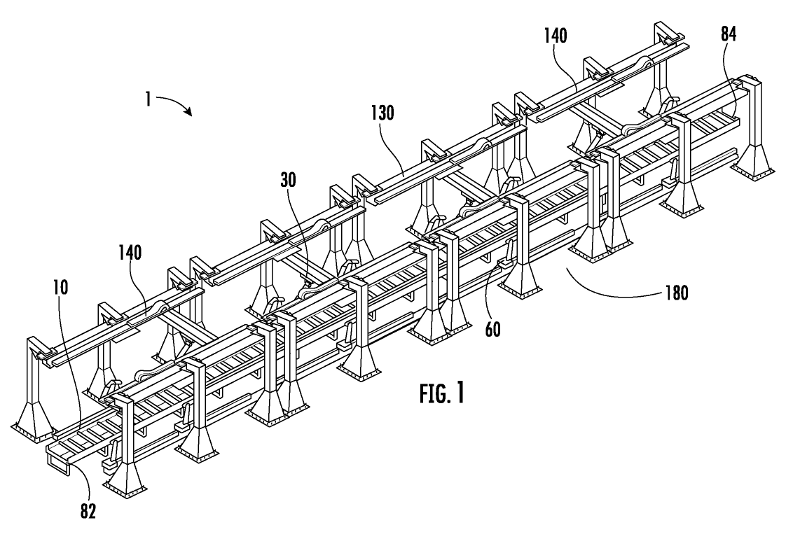

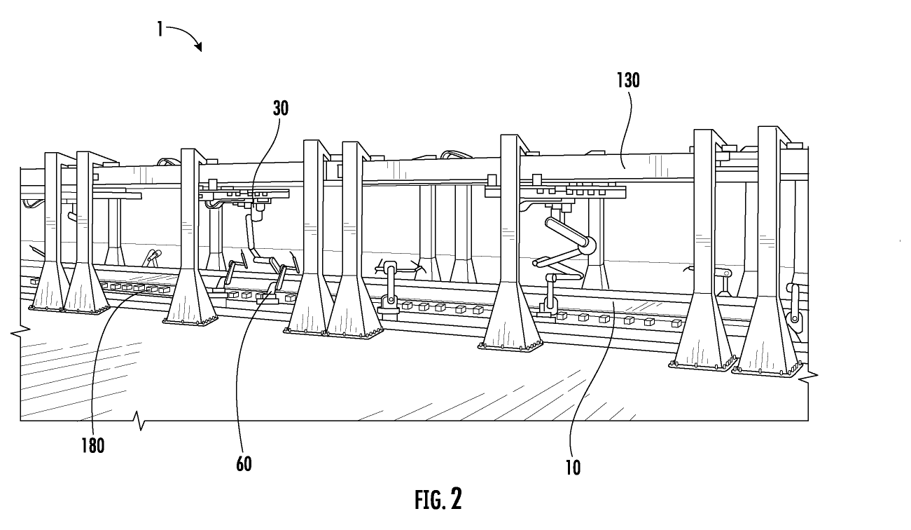

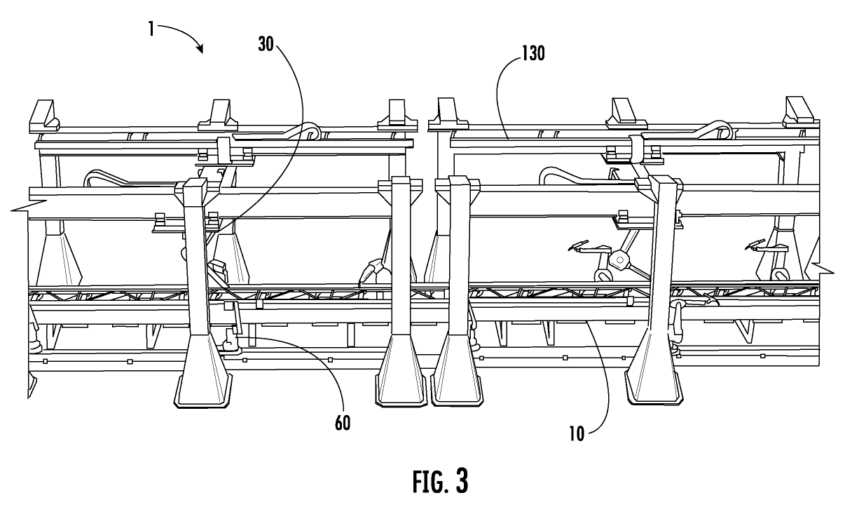

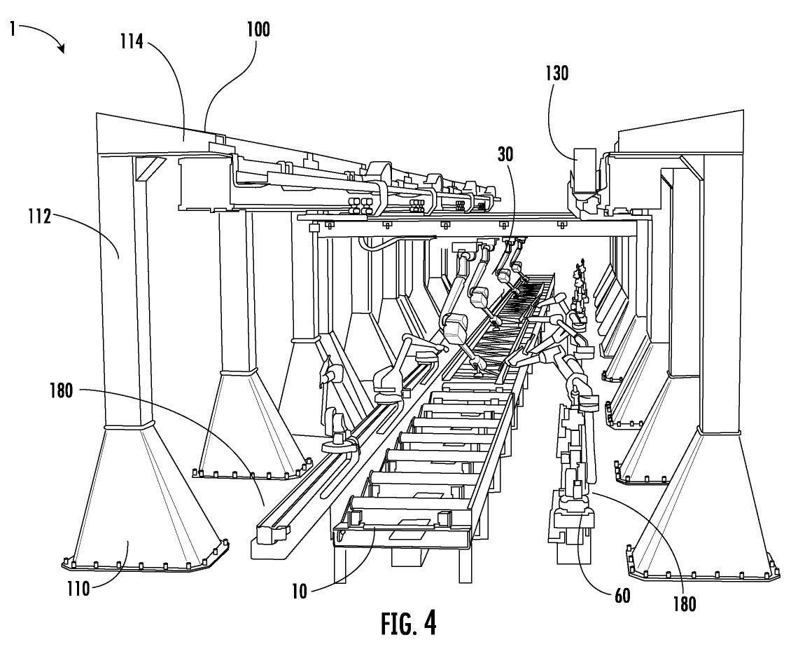

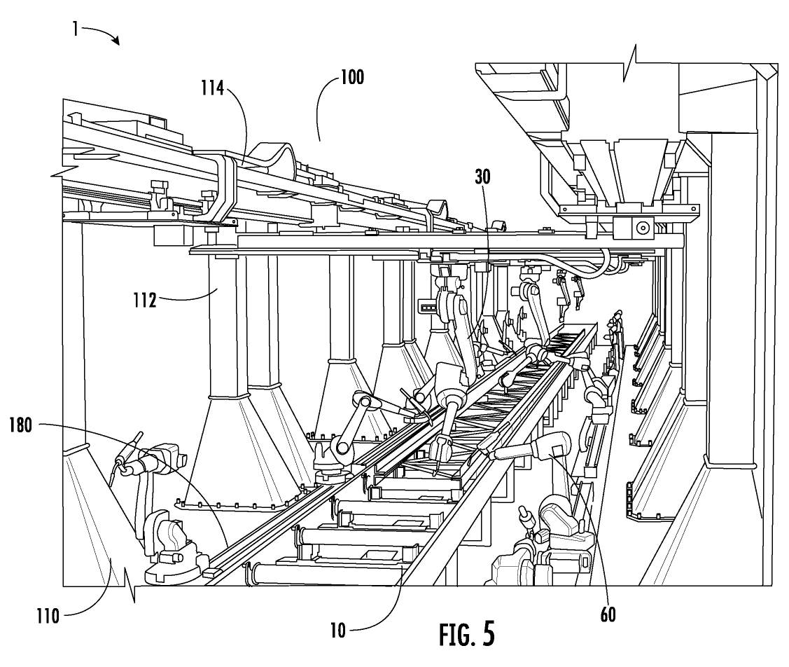

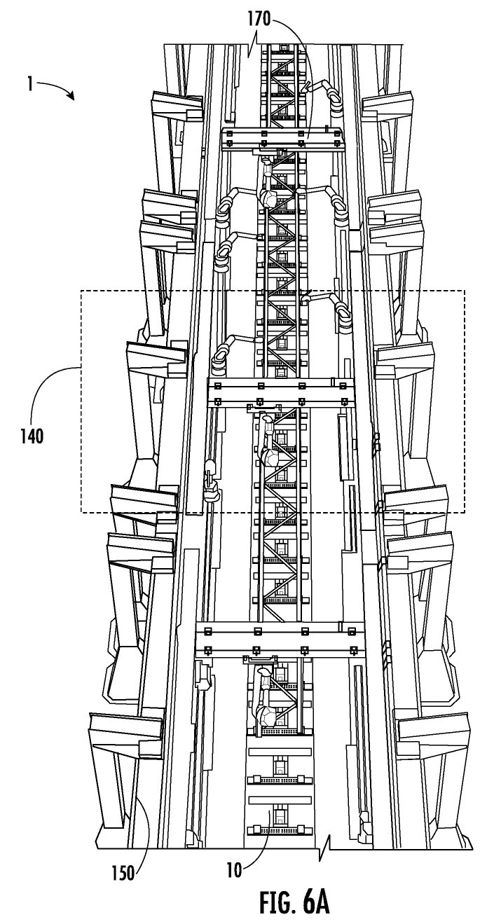

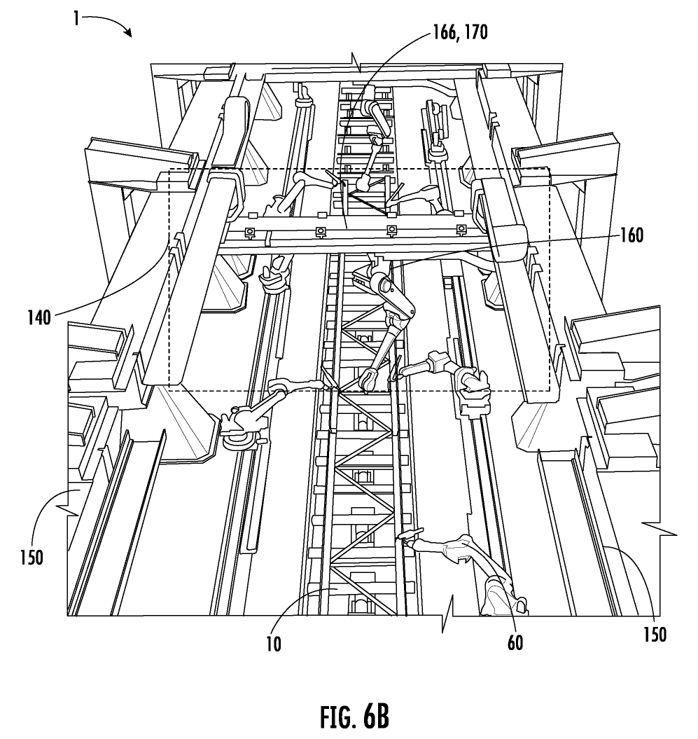

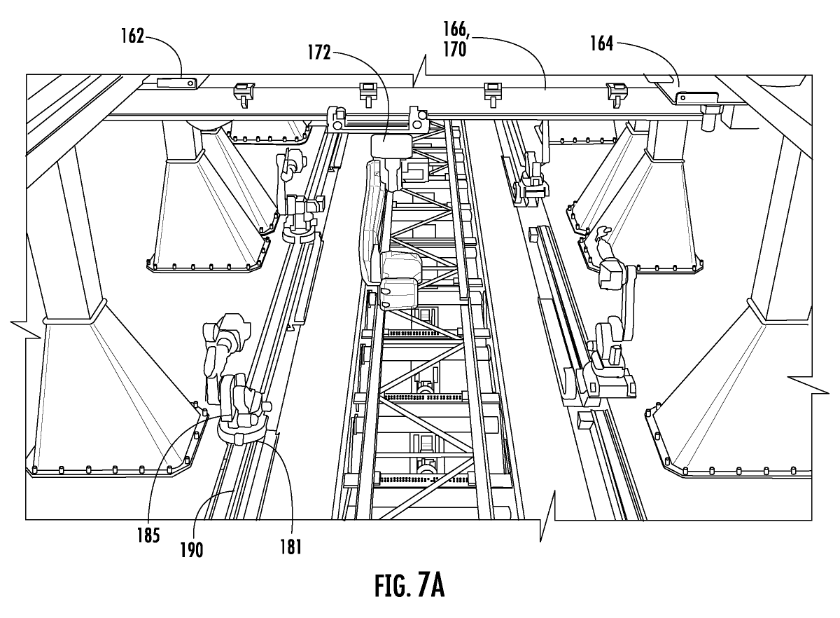

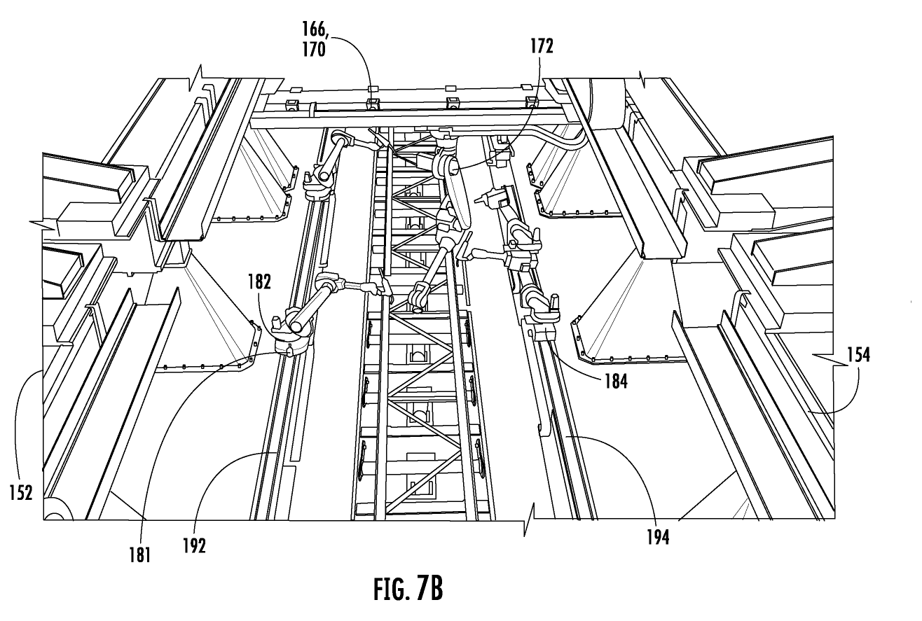

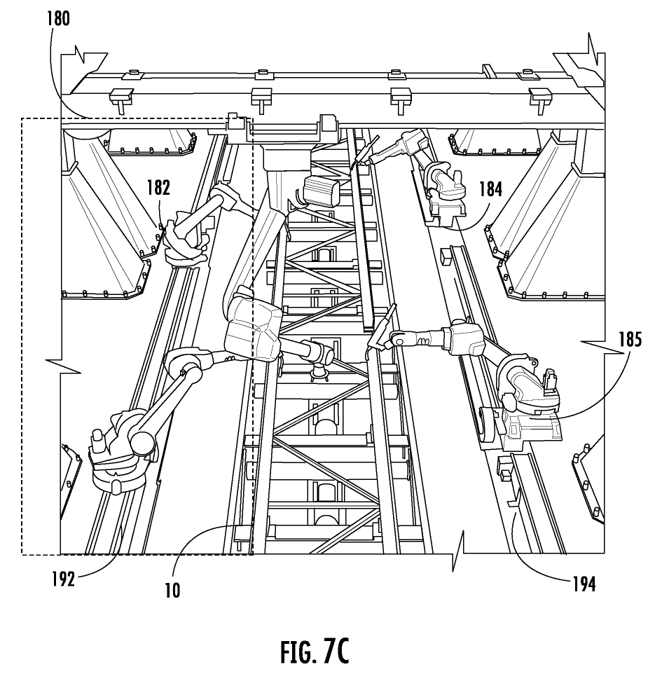

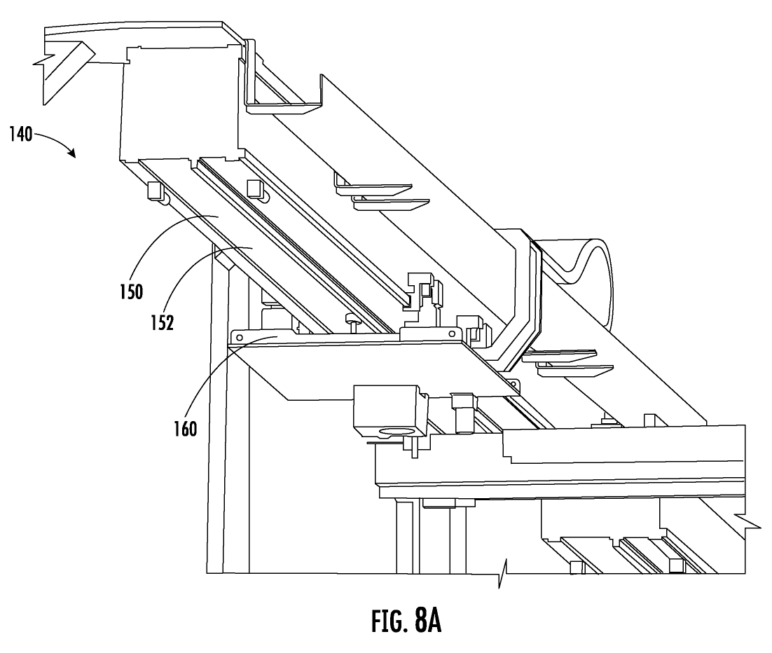

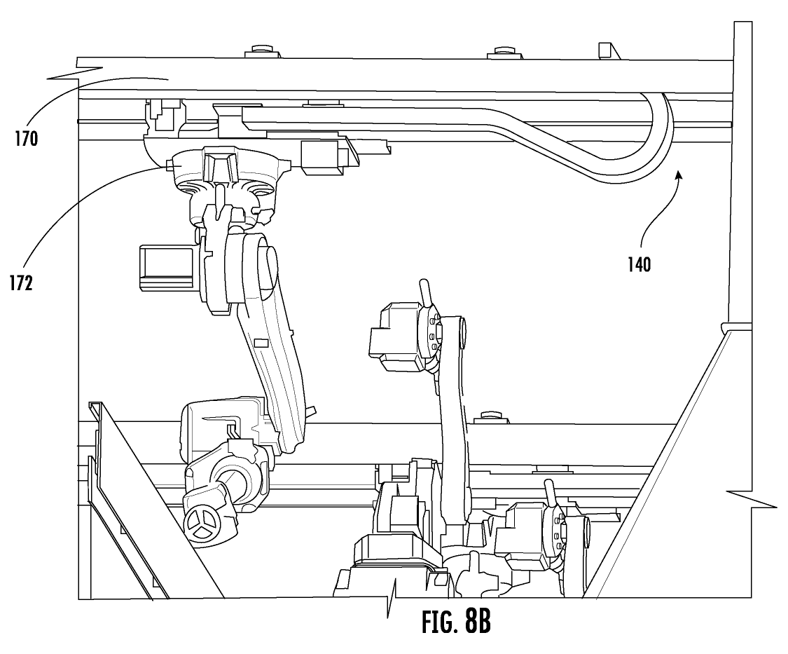

FIGS. 1-10C illustrate various views of the joist assembly system 1, in accordance with embodiments of the invention. The joist assembly system 1 of the present disclosure is structured for dynamic retrieval of components or members 200, dynamic and precise positioning and location of retrieved components or members 200, assembly of the components to form a joist 220, and delivery of the assembled joist 220.

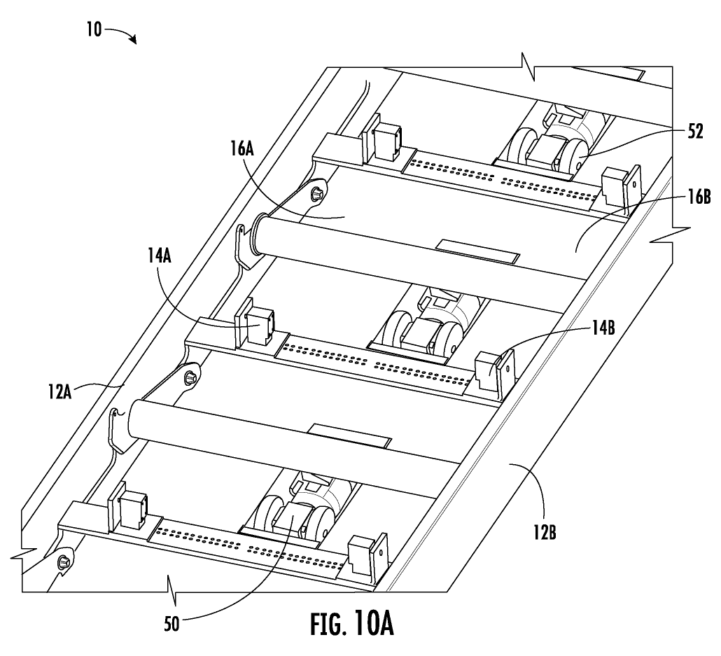

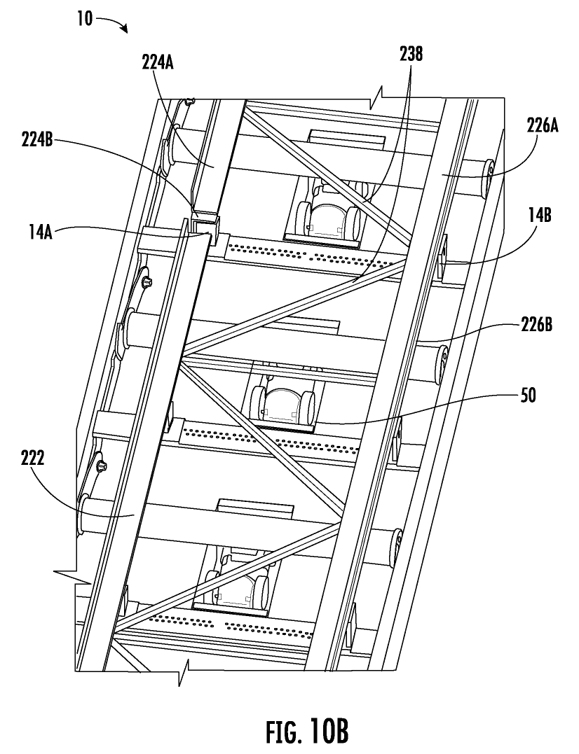

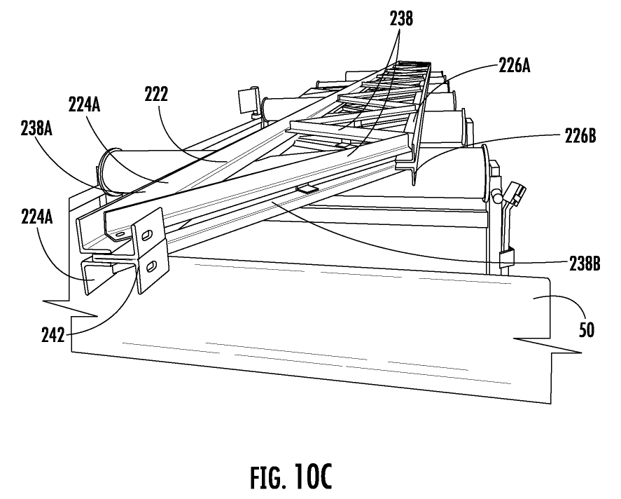

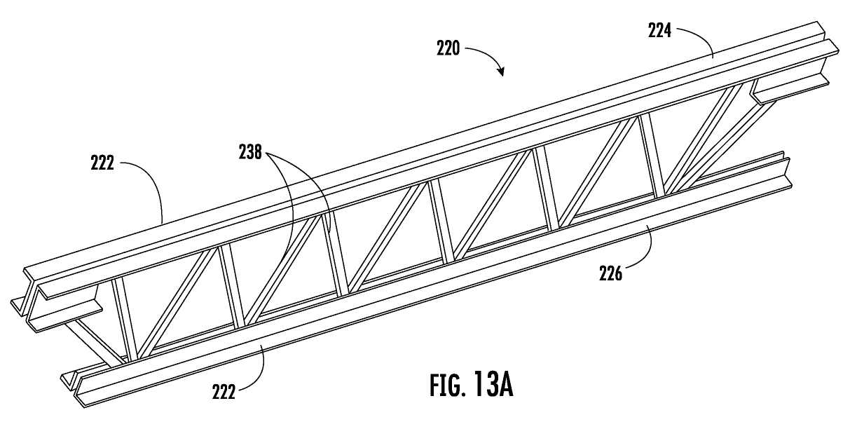

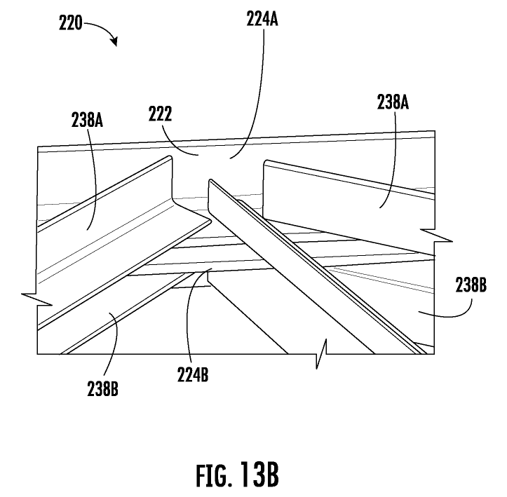

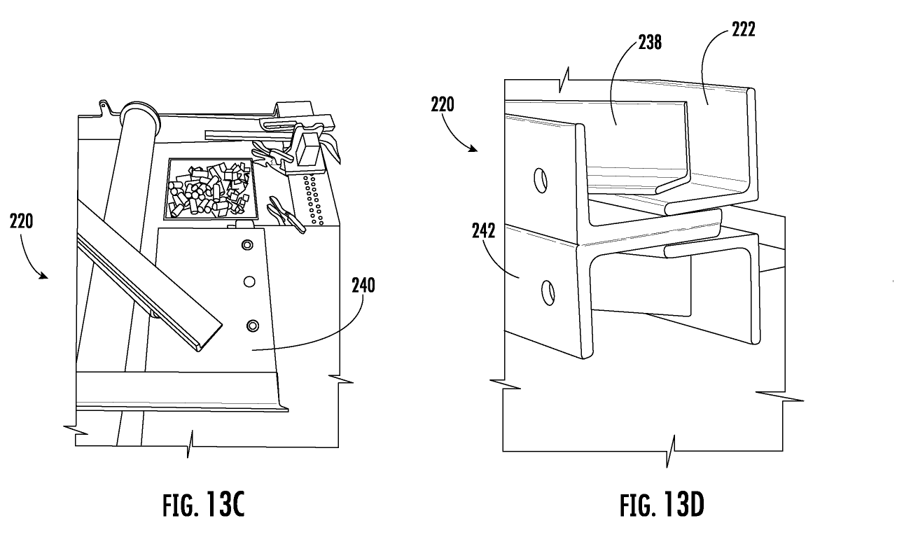

As described herein, the use of the term member 200 and/or component 200 may refer to one or more parts/components that may be assembled together to form a structural member such as a joist 220. Embodiments of a joist 220 are illustrated in FIGS. 10C and 13A-13D for reference. In this regard, the members 200 and/or components 200 may comprise one or more chords 222 and webs 238, or the like, or portions thereof. The chords 222 may comprise one or more upper chords 224 and one or more lower chords 226 with the web members 238 arranged therebetween so that the one or more upper chords 224 and one or more lower chords 226 are spaced apart by a predetermined distance. Moreover, the web members 238 may comprise one or more web members portions that couple the one or more upper chords 224 and the one or more lower chords 226 to each other in different ways. As such, an upper chord 226, lower chord 228, and/or a web members 238 may be made from one or more chord portions or web portions that form the chords 222 and/or webs 280.

It should be understood that the joists 220 formed by the joist assembly system 1 may be associated with joist parameters such as a minimum joist size, maximum joist size, minimum depth, maximum depth, maximum chord size, minimum chord size, number of chord portions, number of web portions, chord position and orientation, web position and orientation, and/or weld lengths. The chords 222 and webs 238 may have any type of shape (e.g., L-shaped, U-shaped, C-shaped, W-shaped, V-shaped, S-shaped, Z-shaped, N-shaped, H-shaped, I-shaped, T-shaped, triangular shaped, round, oval, square, rectangular, non-uniform, or the like). In the illustrated embodiments the chords 222 are formed from two L-shaped members (e.g., back to back), while the webs 238 are formed from a single L-shaped member 238 and/or two L-shaped members 238A, 238B, which are welded between the two L-shaped chord members (e.g., as illustrated in FIG. 13A) or spaced apart and welded on either side of the L-shaped chord members (e.g., as illustrated in FIG. 13B). However, in other embodiments, which are not specifically illustrated in the figures, the chords 222 (e.g., upper chord 224 and/or lower chord 226) may be a single chord (e.g., W-shaped, C-shaped, or the like) to which the webs 238 (of any shape and/or number) are welded. Additionally, the webs 238 may be individual webs 238 (e.g., single straight sections) or at least partially continuous webs 238 that have multiple sections (e.g., V-shaped, W-shaped, multiple V-shaped and/or W-shaped webs that are connected and formed, such as through bends, or other connections). Furthermore, while the members 200 and/or components 200 are generally described as being welded together, other types of connectors (e.g., fasteners, such as bolts, nuts, screw, rivets, pins or the like fasteners, clips, clamps, other types of connectors) may be used to at least partially assemble some of the members 200 and/or components 200 of the joists 220 together.

In some embodiments, as illustrated in FIGS. 13C-13D, the joists may include additional components, such as one or more gusset plates 240 and/or one or more joist seats 242, which may be assembled using the joist assembly system 1. As illustrated in FIG. 13C the one or more gusset plates 240 may be welded to one or more of the chords 222 and/or to one or more webs 238. The gusset plate 240 may be used to couple the joist 220 to another structural member (e.g., a vertical beam, a horizontal beam, a girder, or the like). While the gusset plate 240 is typically in the shape of a rectangular plate, it should be understood that it may have any type of shape (e.g., triangular, square, trapezoidal, any polygonal shape, uniform, non-uniform, or the like). Additionally, or alternatively, the joist seat 242 may be made from one or more members of the same or similar shape as the chords 222 and/or webs 238. As will be described in further detail herein, in some embodiments, the joist seat 242 may be formed from two L-shaped members, and may be coupled to the chords 222 and/or webs 238 in the same or similar way as the webs 238 are coupled to the chords 222. Like the gusset plate 240, the joist seat 242 may be used to couple the joist 220 to another structural member (e.g., a horizontal beam, a girder, or the like).

In general, as illustrated by FIGS. 1-10C, the joist assembly system 1 of the present invention comprises a plurality of material handling systems 30, a plurality of welding systems 60, and a rigging table system 10. Typically, the material handling systems 30 are structured to load and position the components or members 200, such as chords 222 and webs 238 onto the rigging table system 10. However, in some embodiments, the material handling systems 30 may only load and position the chords 222 or the webs 238, and other systems may be utilized to load and position at least some of the members 200. For example, in some embodiments, a chord supply system (not specifically illustrated) may deliver the chords 222 (e.g., one or more upper chords 224 and/or one or more lower chords 226) directly to the rigging table system 10, as will be described in further detail herein. The rigging table system 10 in turn supports the chords 222 and/or webs 238. Subsequently, the plurality of welding systems 60 may weld the webs 238 to the chords 222 to form the joist 220. The assembled joist 220 may then be discharged from the rigging table.

The joist assembly system 1 may comprise an overhead support structure 100 that is at least partially located above the rigging table system 10. For example, the support structure 100 may comprise an overhead mounted support structure 110 (e.g., mounted to the floor, or the like) comprising a plurality of vertical support members 112 coupled to floor supports (e.g., floor decking, floor structural members, concrete, other material, or the like) of a building. The plurality of vertical support members 112 may have one or more support arms 114 that extend from the vertical support members 112. In other embodiments, the support structure 100 may comprise an overhead ceiling mounted support structure 120 having a plurality hanging support members (not specifically illustrated). For example, the plurality of hanging support members may extend at least partially downwardly from one or more overhead ceiling supports (e.g., ceiling supports of an upper floor, of a roof, or the like, such as joists 220, girders, beams, or other horizontal support members). In some embodiments, the overhead support structure 100 may comprise of a crane system (e.g., overhead crane, bridge crane, gantry crane, jib crane, monorail crane, girder crane, or other like crane).

Regardless of the configuration of the overhead support structure 100, the overhead support structure 100 may be used to support an overhead transport system 130 that may be utilized to support the material handling systems 30 and/or the welding systems 60. For example, in the illustrated embodiments, the overhead transport system 130 is used to support the material handling systems 30 (e.g., specifically, the web material handling systems) that may pick, load, position, and/or hold the members 200 for the joist 220 on the rigging table system 10 while the welding systems 60 weld the members 200 together. However, alternatively, the overhead transport system 130 may be used to support the welding systems 60 that are used to weld the members 200 of the joist 220 on rigging table system 10. In still other embodiments the overhead transport system 130 may be used to support a combination of at least some of the material handling systems 30 and the welding systems 60.

It should be further understood that while the figures illustrate a single rigging table system 10 and/or multiple rigging table systems 10 in series, in other embodiments multiple rigging table systems 10 may be located in parallel (e.g., next to each other). As such, the overhead transport system 130 may support single or multiple material handling systems 30 and/or welding systems 60 for multiple rigging table systems 10. Additionally, or alternatively, the overhead support structure 100 may include multiple overhead transport systems 130 (e.g., in series and/or in parallel) for the multiple rigging table systems 10 (e.g., a double-wide overhead transport system 130 configured to supply material to and/or weld the joists 220 of, first and second rigging table systems 10 located in parallel). In some embodiments, while the welding systems 60 may be located on the outside of the rigging tables 10, in some embodiments, the welding systems 60 may also be located between rigging tables 10 located in parallel (e.g., three rows of welding systems 60 located between and outside of two adjacent rigging tables 60). As such, different configurations of the righting tables 10, overhead transport system 130, and/or one or more lower transport systems 180, and/or the material handling systems 30 and/or welding systems 60 are contemplated by the present disclosure.

The one or more rigging table systems 10, the overhead transport system 130 and/or the lower transport systems 180, as will be illustrated and described in further detail herein, may be utilized to provide additional flexibility in producing different sized joists 220 (e.g., smaller joists, long-span joists, or the like) and/or multiple joists 220 on the same or different rigging table systems 10 at the same time, with the use of fewer material handling systems 30 (e.g., material handling robots thereof) and/or welding systems 60 (e.g., welding robots thereof). For example, a rigging table 10 may have material handling systems 30 placing the members 200 and/or components, while another rigging table 10 has automated welding taking place (e.g., tacking, full welding, or the like). Additionally, or alternatively, another rigging table system 10 may have other automated and/or manual processing taking place to fix and/or finish welding and/or to assemble other components to the joists (e.g., joist seats, gusset plates, cross-bracing tabs, or the like). Since welding processes typically take longer than placement of the members 200 and/or components 200, the joist assembly system 1 (e.g., number of rigging tables 10 and/or material handling systems 30 and/or welding systems 60, and the use thereof) may be optimized to increase throughput of the joists 220. As such, improved efficiency may be achieved by the joist assembly system 1 described and/or illustrated herein.

FIGS. 1-10C illustrate embodiments of the joist assembly system 1 (or sub-systems thereof) in further detail. Regardless of how the overhead transport system 130 is supported (e.g., by the floor, by the ceiling of an above floor or the roof, or the like), it may comprise one or more upper transport assemblies 140. For example, a single transport assembly 140 may be used or multiple transport assemblies 140 may be used in series (as illustrated in the figures) and/or in parallel with each other.

The one or more transport assemblies 140 may comprise one or more upper longitudinal tracks 150 and one or more upper longitudinal carriages 160 coupled to the one or more upper tracks 150. The one or more upper carriages 160 move with respect to the one or more upper longitudinal tracks 150.

The one or more upper longitudinal tracks 150 may comprise a single longitudinal track or multiple longitudinal tracks. For example, as illustrated in the figures the one or more longitudinal tracks 150 may comprise a first upper longitudinal track 152 and a second upper longitudinal track 154. The one or more longitudinal tracks 150 may be any type of track of any size and/or shape. As such, the one or more longitudinal tracks 150 may be circular, half-circular, triangular, square, rectangular, any polygonal shape, c-shaped, s-shaped, w-shaped, z-shaped, I-shaped, H-shaped, uniform, non-uniform, or any other shape. Furthermore, a track may have one or more projections extending from the track. The track with or without the one or more projections may be used to support and/or guide the one or more upper carriages 160 along the track 150.

The one or more upper longitudinal carriages 160 may also comprise a first upper carriage mount 162 and a second upper carriage mount 164 that may be coupled by a lateral support member 166. As will be described, the lateral support member 166 may provide the support for the material handling systems 30 and/or the welding systems 60. In some embodiments the lateral support member 166 may be an upper lateral track 170 that allows the material handling systems 30 and/or the welding systems 60 to move laterally with respect to the rigging table system 10.

Each carriage mount 162, 164 may comprise one or more slides (e.g., rollers, bearings, wheels, gears, teeth, or the slide) that allow the carriage 160 slide with respect to the track 150. Moreover, the carriage 160 may also have a drive (e.g., motor, hydraulics, pneumatics, gears, pullies, flexible members – chains, belts, wire, or the like) that moves at least one of the slides and/or is coupled to the track 150 to move the upper carriage 160 with respect to the track 150.

As previously discussed, the lateral support member 166 may be an upper lateral track 170. Moreover, an upper lateral carriage 172 may be coupled to the upper lateral track 170 to allow the material handling systems 30 and/or the welding systems 60 to move with respect to the upper lateral track 170. The upper lateral track 170 and/or the lateral carriage 172 may be the same as, similar to, or different than the upper longitudinal tracks 150 and/or the upper longitudinal carriage 160. As described with respect to the upper longitudinal track 150 and upper longitudinal carriages 160, the lateral carriage 172 may have one or more slides and/or a drive.

Consequently, the material handling systems 30 and/or the welding systems 60 may be able to move longitudinally and/or laterally with respect to the rigging table system 10 in order to provide improved assembly of the joists 220. However, in some embodiments it should be understood that the one or more material handling system 30 and/or the one or more welding systems 60 may only move longitudinally or laterally, or some may move longitudinally while others may move laterally. As such, it should be understood that any combination of longitudinal and/or lateral movement by one or more of the material handling systems 30 and/or one or more welding systems 60 may be contemplated by the present disclosure. Moreover, in some embodiments, the one or more transport assemblies 140 may include one or more tracks and/or one or more carriages that allow movement in various orientations (e.g., diagonally between supports, or the like).

As illustrated in FIGS. 1-10C, the joist assembly system 1 may further comprise one or more lower transport systems 180, which may comprise of one or more lower transport assemblies 181. For example, a single lower transport assembly 181 may be used or multiple lower transport assemblies 181 may be used in series (as illustrated in the figures) and/or in parallel with each other (e.g., on either side of the rigging table system 10, or the like).

The one or more lower transport assemblies 181 may comprise one or more lower longitudinal tracks 190 and one or more lower longitudinal carriages 185 coupled to the one or more lower tracks 190. The one or more lower carriages 185 move with respect to the one or more lower longitudinal tracks 190.

The one or more lower longitudinal tracks 190 may comprise a single longitudinal track or multiple longitudinal tracks (e.g., in series, parallel, or the like, or combinations thereof). For example, as illustrated in the figures the one or more lower tracks 190 may comprise a first lower longitudinal track 192 and a second lower longitudinal track 194. The one or more lower longitudinal tracks 190, like the one or more upper tracks 150, may be any type of track of any size and/or shape. As such, the one or more lower longitudinal tracks 190 may be circular, half-circular, triangular, square, rectangular, any polygonal shape, c-shaped, s-shaped, w-shaped, z-shaped, I-shaped, H-shaped, uniform, non-uniform, or any other shape. Furthermore, a track 190 may have one or more projections extending from the track. The track with or without the one or more projections may be used to support and/or guide the one or more lower carriages 185 along the track 190, thereby allowing the material handling systems 30 and/or the welding systems 60 to move longitudinally with respect to the rigging table system 10.

The one or more lower longitudinal carriages 185 may also comprise a first lower carriage mount 182 and a second lower carriage mount 184 that may be positioned on opposite sides of the rigging table system 10. Each carriage mount 182, 184 may comprise one or more slides (e.g., rollers, bearings, wheels, gears, teeth, or the slide) that allow the lower carriage 180 slide with respect to the track 190. Moreover, the carriage 185 may also have a drive (e.g., motor, hydraulics, pneumatics, gears, pullies, flexible members – chains, belts, wire, or the like) that moves at least one of the slides and/or is coupled to the track 190 to move the lower carriage 185 with respect to the track 190.

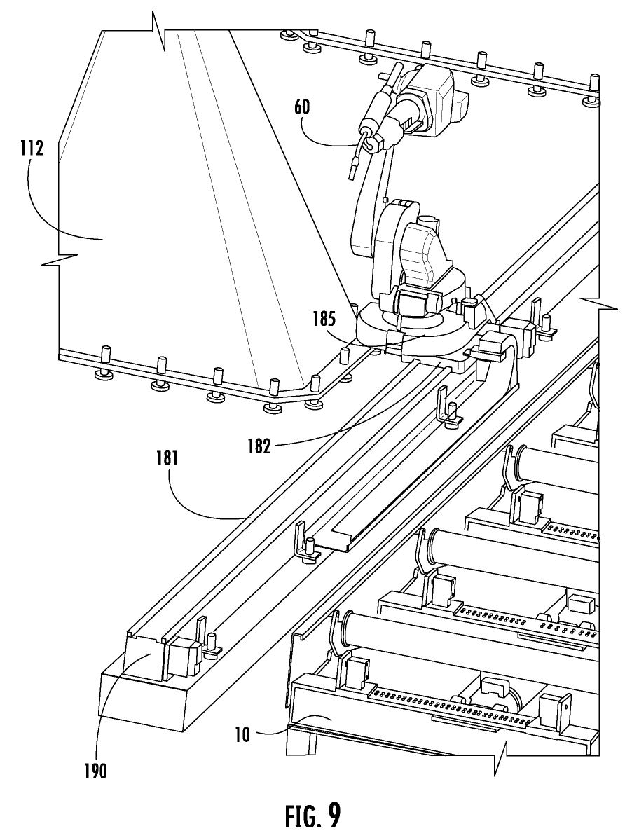

The one or more lower longitudinal tracks 190 may be coupled to one or more floor supports (e.g., floor decking, floor structural members, concrete, or the like) of a building. The first and second lower longitudinal tracks 182, 184 may be positioned on opposite sides of the rigging table system 10. As illustrated in FIG. 9, the one or more lower longitudinal tracks 190 may each be positioned between one or more of the vertical support members 112 and the rigging table system 10 in order to allow the lower carriages 185 to access the rigging table system 10 without being obstructed by the overhead transport system 130.

The joist assembly system 1 may further comprise one or more material supply stations, which are not illustrated. The material supply station is structured to supply (e.g., store, stock, provide, or the like) one or more components or members 200 (e.g., one or more chords 222, webs 238, or the like, or combinations thereof). In this regard, the material supply station may comprise one or more material supply structures (e.g., pallets, racks, tables, bundles, or the like) for storing the one or more components or members 200 (e.g., one or more chords 222 and webs 238). Typically, the material supply station may be structured such that the components or members 200 (e.g., one or more chords 222, webs 238, or the like, or combinations thereof) stored therein may be retrieved by the plurality of material handling systems 30 without obstructing or slowing down the respective material handling system 30. The material supply station may comprise a first picking location that is structured to store one or more chords 222 and a second picking location that is structured to store one or more web members 238. The material supply station may be located on the floor of the building or may be provided at a raised or elevated level in order to allow the upper transport assemblies 140 to access the chords 222 and/or webs 238 and move the components to the rigging table system 10. As such, the one or more chords and/or webs 238 may be located in the same material supply station or different material supply stations located above, below, or adjacent one another. In still other embodiments, at least some of the components or members 200 may be supplied at the end of the joist assembly system 1, such as at the end of the joist table system 10 (e.g., delivered in-line at an entry end of the of the joist table system 10).

### Material Handling Systems

As discussed, the joist assembly system 1 comprises a plurality of material handling systems 30. Typically, the material handling systems 30 are structured to load (e.g., pick, grip, clutch, or the like) members 200 (e.g., one or more chords 222, webs 238, or the like) stored at a respective picking location at the material supply station, transport them to the rigging table system 10 and subsequently position the members 200, such as chords 222 and/or webs 238, onto the rigging table system 10 in a predetermined position and orientation for assembly. Moreover, the material handling system 30 may hold (e.g., maintain, or the like) the members 200 in their correct position/orientation while a plurality of welding systems 60 couple (e.g., weld, or the like) the members 200 together, thereby precluding any undesirable displacement during the joining process. Additionally, or alternatively, as will be discussed herein one or more projections (e.g., jigs, or the like) may be used to hold the members 200 in the correct position/orientation (e.g., with or without the use of the material handling system 30) for welding.

As described, the joist assembly system 1 may comprise the plurality of material handling systems 30 being supported by the overhead transport system 130. However, in other embodiments, one or more material handling systems 30 may be provided elsewhere, such as at a lower transport assembly 181. Moreover, the plurality of material handling systems 30 may further comprise a plurality of chord material handling systems 32 that are structured for loading (e.g., picking, transporting, and positioning) one or more chords 222, such as one or more upper chords 224 and/or one or more lower chords 226. The plurality of material handling systems 30 may further comprise a plurality of web material handling systems 34 that are structured for loading (e.g., picking, transporting, and positioning) one or more web members 238. As such, in some embodiments the one or more material handling systems 30 may be configured to load both chords 222 and webs 238, or may be specialized such that some material handling systems 30 load only chords 222 while other material handling systems 30 load only webs 238.

In some embodiments, the plurality of material handling systems 30 may be automated (e.g., controllable and/or programmable) machines, such as robots, robotic arms, and/or the like. In this regard, the plurality of material handling systems 30 may comprise an end effector that is structured to pick (e.g., grip, clutch, hold, position, rotate, and/or the like) one or more respective members 200 (e.g., one or more chords 222, one or more webs 238, or the like, or combinations thereof). The plurality of material handling systems 30 may be a cartesian robot whose axes are associated with a cartesian coordinate system, a cylindrical robot whose axes are associated with a cylindrical coordinate system, a spherical or polar robot whose axes are associated with a polar coordinate system, an articulated robot such as a 6 axis articulated robot, or the like (e.g., an articulated robot having at least 1, 2, 3, 4, 5, or the like degrees of freedom). As such, the plurality of material handling systems 30 may have one or more arms coupled in series, parallel, or combinations thereof. For example, the plurality of material handling systems 30 may have a base, a first arm, a second arm, and end effectors coupled in series at each arm end, and such each arm and/or end effector may move (e.g., hinged, rotate, or the like) with respect to each other. The plurality of material handling systems 30, and their end effectors in particular, may comprise multiple degrees of freedom, such as 6 degrees of freedom, to allow for the required picking (e.g., gripping, clutching, holding, positioning, rotating, and/or the like) the one or more respective members 200 (e.g., one or more chords 222 and one or more webs 238). Moreover, the plurality of material handling systems 30, and their end effectors in particular, may be moved (e.g., actuated, controlled, and/or operated) via an actuator (e.g., hydraulic, pneumatic, electric, and/or the like) of the plurality of material handling systems 30.

As discussed above, the plurality of material handling systems 30 may comprise a plurality of chord material handling systems 32 that are structured for loading (e.g., picking, transporting, positioning, and/or the like) one or more chords 222, such as one or more upper chords 224 and/or one or more lower chords 226. In this regard, the respective end effectors (also referred to as material handling grippers) of the plurality of chord material handling systems 32 are structured to pick (e.g., grip, clutch, position, rotate, and/or the like) the chords 222, without interference from or without interfering with the respective material supply station and other staging and tooling components of the rigging table system 10. Similarly, the plurality of material handling systems 30 may further comprise a plurality of web material handling systems 34 that are structured for loading (e.g., picking, transporting, positioning, or the like) the one or more web members 238. In this regard, the respective end effectors (also referred to as material handling grippers) of the plurality of web material handling systems 34 are structured to pick (e.g., grip, clutch, position, rotate, and/or the like) the web members 238, without interference from or without interfering with the respective material supply station and other staging and tooling components of the rigging table system 10.

Moreover, in some embodiments, the end effectors (also referred to as material handling grippers) of the plurality of chord material handling systems 32 and/or web material handling systems 34 are structured such that undesirable movement of chord members 222 and/or web members 238 during the loading (e.g., picking, transporting, positioning, or the like) process, even during high speed movements, is restricted. Moreover, in some embodiments, the end effectors (also referred to as material handling grippers) of the plurality of chord material handling systems 32 and/or web material handling systems 34 are structured to pick chord members 32 and/or web members 238 of a variety of lengths, and using a variety of grips such grip low, grip high, or the like.

In some embodiments, the plurality of material handling systems 30, and/or a controller 1550 (described in further detail later) associated with the plurality of material handling systems 30 and/or the joist assembly system 1 are structured to measure a picking location and time for each of the chords 222 and/or web members 238 from their respective material supply station. In some embodiments, the plurality of material handling systems 30, and/or the controller 1550 may construct and utilize the same path for loading and transport of chord members 222 and/or web members 238 of the same or different lengths. In some embodiments, the plurality of material handling systems 30, and/or the controller 1550 may optimize a path for loading of chord members 222 and/or web members 238 of the same or different lengths. In some embodiments, the plurality of material handling systems 30, and/or the controller 1550 may construct and utilize varying paths for loading of chord members 222 and/or web members 238 of varying web lengths.

In some embodiments the joists 220 (e.g., chords 222 and/or web members 238) thereof may have bracing clips (e.g., paddle clips, or the like) that are used for cross-bracing between joists 220 when the joists 220 are installed in a building. Moreover, the joists 220 (e.g., chords 222 and/or web members 238) may have spacers (e.g., fillers, or the like) that are used to space the first upper chord portion 224a apart from the second upper chord portion 224b and/or the first lower chord portion 226a apart from the second lower chord portion 224b. It should be understood that in some embodiments, the bracing clips (not illustrated) and/or the spacers (not illustrated) may be installed on the chords 222 and/or webs 238 prior to being delivered to the material supply station 40. In some embodiments, the bracing clips and/or spacers may be coupled to the chords 222 and/or webs 238 prior to the chords 222 and/or webs 238 being provided to the material supply station, within the material supply station, and/or after the material supply station. The bracing clips may be coupled (e.g., welded, or the like) by users physically welding the bracing clips to the chords 222 and/or webs 238. In some embodiments, a locating system (not illustrated) having a laser, light curtain, etcher, marking device, or the like may mark locations on the chords 222 and/or webs 238 in order to indicate where the bracing clips and/or spacers should be coupled to the chords 222 and/or webs 238. The users may pre-assemble or post-assemble the bracing clips to the chords 222 and/or webs 238. The users may also pre-assemble the spacers to the chords 222. In this way, it should be understood that the pre-welding of the bracing clips and/or spacers may improve the throughput of the joist assembly system 1. That is, the pre-welding may reduce the number of operations (e.g., welding operations, positioning operations, or the like) that are performed by the joist assembly system 1, thus reducing the assembly time of the joist 220 within the joist assembly system 1.

Alternatively, in some embodiments the bracing clips and/or spacers may be positioned automatically by the material handling systems 30 and/or automatically welded by the welding systems 60. As such, the plurality of material handling systems 30, and/or a controller 450 associated with the plurality of material handling systems 30 and/or the joist assembly system 1 may be structured to determine a picking location and time for the predetermined small parts (e.g., bracing clips, spacers, or the like) associated with the joist 220 from their respective material supply station 40. The plurality of material handling systems 30, and/or the controller 450 may place the bracing clip (e.g., paddle clip, or the like) within a placement tolerance of about +/-1 inches along a linear direction and/or a bracing clip placement tolerance of about -1/8 to 0 inches from top and bottom chord faces, and may place the spacer (e.g., filler, or the like) within a placement tolerance of about +/-2 inches in a linear direction and/or a spacer placement tolerance of about 0 to 0.25 inches inboard from far side chord face.

In some embodiments, the plurality of material handling systems 30 are structured to move through placement of respective chords 222 and/or web members 238 in a semi-coordinated and/or fully-coordinated motion. In this regard, a controller 1550 associated with the plurality of material handling systems 30 and/or the joist assembly system 1 may determine or construct cycle times for assembling the joists 220 (e.g., retrieval, transport, positioning, joining, assembly, and/or the like steps) for each of the chords 222 and/or web members 238, and coordinate movement and actions of the plurality of chord material handling systems 32 and plurality of web material handling systems 34, accordingly. In some embodiments, the plurality of material handling systems 30 may be configured to place and position the respective chords 222 and/or web members 238 onto the respective locations of the rigging table system 10 at a predetermined maximum speed of semi-coordinated motion, while in other embodiments, the plurality of material handling systems 30 may switch to a predetermined medium or slow speed (or a soft speed mode) for certain steps such as positioning of the respective chords 222 and/or web members 238 onto the respective locations of the rigging table system 10.

Moreover, the plurality of material handling systems 30 are configured for loading respective chords 222 and/or web members 238 within a predetermined tolerance. In this regard, the plurality of material handling systems 30 may be associated with or configure an outline envelope and repeatedly place the respective chords 222 and/or web members 238 within the window at a predetermined high speed. The plurality of material handling systems 30 are further configured to detect any collisions (and/or prevent subsequent collisions after a collision has been detected). In some embodiments, the plurality of material handling systems 30 are associated with a chord member 222 and/or web member 238 placement tolerance of about +/- 0.5 inches along a linear direction. In some embodiments, the plurality of material handling systems 30 are associated with a chord member 222 and/or web member 238 placement tolerance of about +/- 0.01, +/- 0.05, +/- 0.1 , +/- 0.2, +/- 0.3, +/- 0.4, +/- 0.5, +/- 0.6, +/- 0.7, +/- 0.8, +/- 0.9, and/or +/- 1 inches, along a linear direction, and/or within a tolerance range with any combination of limits selected from the foregoing. In some embodiments, the plurality of material handling systems 30 are associated with a web member 238 placement tolerance of about -0.25 to +0 inches with respect to top and bottom chord faces. In some embodiments, the plurality of material handling systems 30 are associated with a web member 238 placement tolerance of about -0.1 to + 0.1 inches, -0.2 to + 0.2 inches, -0.5 to + 0.5 inches, -0.25 to + 0.1 inches, -0.2 to + 0.1 inches, -0.25 to + 0.25 inches, -0.3 to + 0.3 inches, -0.5 to + 0.5 inches, -0.5 to + 0.1 inches, -0.4 to + 0.1 inches, and/or -1 to + 0.5 inches, with respect to top and bottom chord faces, and/or within a tolerance range with any combination of limits selected from the foregoing.

As discussed, the material handling system 30 may hold or maintain the chords 222 and/or web members 238 in their correct position/orientation while a plurality of welding systems 60 join (e.g., weld) the components or members 200 together, thereby precluding any undesirable displacement during the joining process. Here, the plurality of material handling systems 30 may further apply a predetermined downward force onto the chords 222 and/or web members 238 in their correct position/orientation over the rigging table system 10 during the joining process. The controller 1550 associated with the plurality of material handling systems 30 and/or the joist assembly system 1 may determine/measure an applied downward force (e.g., a human downward force during configuration) and fit-up. The controller 1550 may then compare a downward force associated with the plurality of material handling systems 30, and control the plurality of material handling systems 30 such that the downward force of the plurality of material handling systems 30 meets or exceeds the applied downward force (e.g., a human downward force during configuration). Moreover, the controller 1550 may verify contact between a web member 238 and a respective top/bottom chord 222, when positioned for assembly on the rigging table system 10, such as through the use of one or more sensors (e.g., cameras, IR, lasers, LIDAR, proximity sensors, force, or the like sensors).

In some embodiments, the plurality of material handling systems 30 are structured for camber match (e.g., via a soft speed mode). In this regard, the controller 1550 may utilize a largest chord 222 to simulate the foregoing. The controller 1550 may verify contact with the chord members 222 using camber match tooling (e.g., associated with the rigging table system 10 such as chord projections and/or web jigs). The controller 1550 may further verify contact with web members 238 from the applied downward force, which in some embodiments, may be based on determining consistent web members 238, identifying web members 238 that may not contact the chords, and/or a gap tolerance of +/-1/8 inches with respect to the chords 222 (e.g., don’t extend over and/or under a chord).

In some embodiments, the plurality of material handling systems 30 and/or the controller 1550 may measure structure deflection during the loading (e.g., retrieval, placement, or the like) processes. Moreover, the plurality of material handling systems 30 and/or the controller 450 may minimize the deflection such that the placement of the chords 222 and/or the web members 238 is not adversely affected.

### Rigging Table System

As illustrated by FIGS. 1-10C, the joist assembly system 1 of the present invention comprises a rigging table system 10. Typically, the rigging table system 10 supports the chords 222 or webs 238 positioned thereon (e.g., by the plurality of material handling systems 30, or other material supply stations). Concurrently and/or subsequently, the plurality of welding systems 60 may join (e.g., weld) the webs 238 to the chords 222 to form the joist 220. The assembled joist 220 may then be discharged from the rigging table 1 and transported therefrom. In some embodiments, the rigging table system 10 comprises a generally elongate table 80 arrangement extending from a first table end 82 to an opposite second table end 84. The rigging table system 10 may define a first table side 12a (e.g., a first lateral side) and an opposite second table side 12b (e.g., a second lateral side), where the first table side 12a is adjacent the first longitudinal track 182 and the second table side 12b is adjacent the second longitudinal track 184. Moreover, the rigging table system 10 may extend to a height between the floor and the overhead transport system 130.

In some embodiments, the rigging table system 10 comprises one or more upper chord projections 14a having one or more upper chord cavities 16a and/or one or more lower chord projections 14b having one or more lower chord cavities 16b. In some embodiments, a plurality of upper chord projections 14a may be spaced apart to form a plurality of upper chord cavities 16a. The plurality of upper chord projections 14a together with the plurality of upper chord cavities 16a are structured to hold and support a chord 222 such as a first upper chord portion 224a of an upper chord 224. Moreover, the rigging table system 10 may comprise a plurality of lower chord projections 14b spaced apart to from a plurality of lower chord cavities 16b. The plurality of lower chord projections 14b together with the plurality of lower chord cavities 16b are structured to hold and support a chord 222 such as a first lower chord portion 226a of a lower chord 226. Moreover, the plurality of upper chord projections 14a and/or the plurality of lower chord projections 14b allow the first upper chord portion 224a of the upper chord 224 to be spaced different distances apart from the first lower chord portion 226a of the lower chord 226 to allow for assembly of a joist 220 of any required dimensions. In some embodiments, a controller 1550 associated with the plurality of material handling systems 30 and/or the joist assembly system 1 may trigger or cause positioning the chords 222 and web members 238 on the rigging table system 10 in accordance with programmed joist parameters for the assembled joist 220. The web members 238 may be positioned and held in place by the material handling system 30. Specifically, in some embodiments, the web members 238 may be positioned and held in place by one or more material handling systems 30 of the overhead transport system 130. As discussed, the joist parameters may comprise minimum joist size, maximum joist size, minimum depth, maximum depth, and maximum or minimum chord length, chord depth, web position and orientation, weld lengths, and/or the like.

In some embodiments, the rigging table system 10, and/or the plurality of upper chord projections 14a and plurality of lower chord projections 14b, comprise stop members (e.g., pneumatic camber induction drives, or the like) structured to provide a stop for all chord sizes. It should be understood that the plurality of upper chord projections 14a and plurality of lower chord projections 14b may be adjustable to support joists of different sizes and/or shapes (e.g., different heights, different shapes, or the like). For example, the plurality of upper chord projections 14a and the plurality of lower chord projections 14b may move laterally and/or longitudinally on the rigging table 80 to change the distance between the one or more upper chords 224 and/or one or more lower chords 226. Furthermore, the plurality of upper chord projections 14a and the plurality of lower chord projections 14b may move with respect to each other to accommodate chords 222 of different shapes (e.g., moved closer for L-shaped members, but moved farther apart to support C-shaped members). Additionally, or alternatively, the plurality of upper chord projections 14a and the plurality of lower chord projections 14b may move with respect to each other to accommodate chords 222 that are bent (e.g., curved, have angles, or the like), or otherwise, to bend a chord 222 as it sits on the table 80 to form a joist 220 that has a bent shape (e.g., curved, or the like).

The rigging table system 10 further comprises a discharging system 50. Typically, the discharging system 50 comprises plurality of rollers 52 that may be retracted to allow for positioning of the components or members 200 such as chords 222 and webs 238 onto the rigging table system 10, and extended in an upward and/or rotational direction to allow for discharge and transport of an assembled joist 220 after the joining (e.g., welding, or the like) process. In this regard, the discharging system 50 is structured to move the assembled joist 220 after the joining (e.g., welding, or the like) from the rigging table system 10, and/or from the plurality of upper chord projections 14a and plurality of lower chord projections 14b.

### Welding Systems

As illustrated by FIGS. 1-10C, the joist assembly system 1 of the present invention comprises plurality of welding systems 60 that are structured to join (e.g., via welding) the members 200 such as chords 222 and webs 238 positioned on the rigging table system 10. The joining (e.g., welding, or the like) may be performed in accordance with the required joist parameters. The plurality of welding systems 60 may be coupled to the one or more lower transport systems 180 (e.g., over the floor). Moreover, the plurality of welding systems 60 may comprise a plurality of first welding systems 62 provided proximate the first table side 12a of the rigging table system 10, and plurality of second welding systems 64 provided proximate the second table side 12b of the rigging table system 10. In other words, the rigging table system 10 may be positioned between the plurality of first welding systems 62 and the plurality of second welding systems 64. That said, more or fewer welding systems may be provided. Typically, each of the plurality of welding systems 60 may comprise one or more welding arms that are structured to extend over the rigging table system 10 and join (e.g., weld) members 200 such as chords 222 and webs 238 positioned thereon. In some embodiments, the plurality of welding systems 60 may have a weld head structured for arc welding, laser welding, gas welding, flux welding, TIG welding, MIG welding, FCAW welding, plasma welding, electron beam welding, brazing, and/or the like in order to form the joist 220. In other embodiments, the welding system 60 may be joining systems that provide for other joints other than welding, such as riveting, self-taping and/or self-drilling fasteners, other fasteners that are inserted into an aperture, and/or other joining operations to form the joist 220.

The robots of the plurality of welding systems 60 may be the same as or similar to the robots of the plurality of material handling systems 30 (e.g., configurations, such as number of arms, drives, degrees of freedom, or the like, and/or the operation thereof). However, instead of an end effector at the end of the robot used to pick members 200, end of the robot is a welding assembly. Typically, the plurality of welding systems 60 comprise a default retracted position. The plurality of welding systems 60, and/or welding arms thereof, are structured move from the default position to reach side to side to cover a predetermined associated work area (also referred to as a work envelope) thereby moving to a joining position (or a welding position). Here, the plurality of first welding systems 62 may be coupled to the first lower carriage 182 (e.g., proximate the first table side 12a of the rigging table system 10, while the plurality of second welding systems 64 may be coupled to the second lower carriage 184 (e.g., proximate the second table side 12b of the rigging table system 10. The time for the movement of the plurality of welding systems 60, and/or welding arms thereof from the default position to the joining position may be measured by the controller 1550. Furthermore, the controller 1550 may be configured to synchronize the operations of the welding systems 60, such as the first welding system 62 and second welding system 64 such that the first and second welding systems 62, 64 operate simultaneously.

In some embodiments, each of the plurality of welding systems 60 may be associated with a maintenance position, such as a torch maintenance position. The plurality of welding systems 60 may be associated with a torch maintenance cycle which may be performed after the joining/welding process is complete. For example, the torch welding maintenance position may be used for cleaning the nozzle of the welding robot between welding of one or more joists 220 (e.g., between each joist, or a run of two or more joists). As such, during or after the joist 220 is discharged from the rigging table system 10, the welding systems 60 move from the joining position and/or a retracted position into a torch maintenance position. In some embodiments the torch maintenance position may occur in the retracted position. In the torch maintenance position, the welding tips of the welding systems 60 may be cleaned (e.g., using wire brushes, cleaning solution, or the like).

Moreover, the plurality of welding systems 60 are collectively structured to reach all the weld locations of the joist 220. Moreover, the lower transport assemblies 181 allow the welding systems 60 move longitudinally with respect to the one or more joists 220 being assembled to allow the welding systems 60 to make the necessary welds. The longitudinal movement of the welding systems 60 may allow for a reduced number of welding systems 60 that would have been required to make the welds if the welding systems 60 were static. Moreover, the robots of the welding systems 60 may have a minimum reach, range, or depth of around 20 inches. Moreover, the plurality of welding systems 60 are associated to perform the associated joining process such as welding in accordance with joining parameters such as weld depth. In some embodiments, the plurality of welding systems 60 may perform the associated joining process such as welding in accordance with weld criteria such as preventing/minimizing surface bubbles or cracks, maximum allowed undercutting of about 0.03 or 0.03125 inches, preventing/minimizing gouges or nicks, maximum sum of surface piping (porosity) not exceeding 1/16 inches in any 1 inch of weld, welds not being less than the material thickness for webs less than ¼ inch thick, otherwise the weld being the material thickness -1/16 inches, the maximum single pass weld being 5/16 inches, or the like.

While not specifically illustrated in the figures, the welding systems 60 may also be able to move laterally. For example, the welding systems 60 may be able to move laterally in the same or similar way as previously described with the respect to the movement of the material handling systems 30 and/or welding systems 60 of the overhead transport assembly 130 (e.g., lateral tracks, carriages, drives, or the like). Additionally, or alternatively, the welding systems 60 may be able to move laterally using other configurations, such as moving the lower transport assemblies 181 and/or the lower tracks (or a portion thereof) laterally with respect to the rigging table systems 10 and/or moving the rigging table systems 10 with respect to the lower transport assemblies 181. As such, the lateral movement may allow for increased flexibility with respect to assembling joists 200 of different sizes (e.g., different depths, or the like). In some embodiments the welding system 60 may move independent of a track. For example, the welding systems 60 may have one more independent transport systems (e.g., wheels, slides, motors, or the like) that may allow the welding systems 60 to move in any direction independently of a fixed position.

### Operation of the Joist Assembly System

The functioning of the joist assembly system 1 will now be described in detail. Specifically, the overhead transport system 130, via the material handling systems 30, may load a first upper chord 224 and a first lower chord 226 from the material supply station and transport them towards the rigging table system 10. The material handling systems 30 may be configured to turn, rotate, and/or otherwise orient the chord members 222 before or during delivery to the rigging table system 10. In other embodiments, the first upper chord 224 and the first lower chord 226 may be delivered at the end of the rigging table system 10. The material handling systems 30 may then position the retrieved first upper chord 224 and first lower chord 226 at the rigging table system 10 at an assembly location as illustrated by FIG. 10B. Here, as illustrated, the first upper chord 224 may be positioned proximate the first table side 12a of the rigging table system 10 and the first lower chord 226 may be positioned proximate the second table side 12b of the rigging table system 10, with the first upper chord 224 and the first lower chord 226 being spaced apart by a predetermined distance. However, it should be understood that the chords may be positioned on either side of the rigging table system 10. Moreover, in some embodiments the upper chord and/or the lower chord may be single chords (e.g., having only one portion) that are positioned in the same or similar way as described above.

Specifically, as depicted by the detail view of FIGS. 10A-10B, the first upper chord 224 is positioned at the plurality of upper chord projections 14a such that first upper chord portion 224a is at least partially within the plurality of upper chord cavities 16a. In other words, the first upper chord 224 is held in place and supported by the plurality of upper chord projections 14a in conjunction with the plurality of upper chord cavities 16a. Moreover, the first lower chord 226 is positioned at the plurality of lower chord projections 14b such that first lower chord portion 226a is at least partially within plurality of lower chord projections 14b. In other words, the first lower chord 226 is held in place and supported by the plurality of lower chord projections 14b in conjunction with the plurality of lower chord cavities 16b. The first upper chord 224 and first lower chord 226 may, additionally or alternatively, continue to be held in place by the material handling systems 30, which may be configured to apply a predetermined amount of downward force to the upper and lower chord 224, 226. Furthermore, in some embodiments, one or more retaining members (e.g., clamps, fingers, or the like) may actuate to restrict the movement of the chords 222 (e.g., clamp the chords in place).

Next, a second set of material handling systems 30 may load (e.g., retrieve, transport, position, or the like) a first set of web members 238 from the material supply station, and may transport the first set of web members 238 to the rigging table system 10. In some embodiments, the second set of material handling systems 30 may turn, rotate, and/or otherwise orient the web members 238 in accordance with the required structure of the joist 222, while the web members 238 are being transported towards the rigging table system 10.

Next, the second set of material handling systems 30 position the one or more webs 238 (e.g., a first set of web members 238) at the rigging table system 10 between the already positioned first upper chord 224 and first lower chord 226. As depicted by the detail view of FIG. 10B, the first set of web members 238 are positioned by second set of material handling systems 30 at a predetermined position, angle, spacing, and/or the like in accordance with the required structure of the joist 220. Moreover, the web members 238 may be positioned relative to the upper chord 224 and lower chord 226 such that each of the web members 238 forms at least one joining location (e.g., welding location) with the upper chord 224 and/or the lower chord 226. Here, at least a portion of each end of each of the web members 238, as well as any bends of webs that are at least partially continuous, may be positioned to be proximate (e.g., contact, overlap, or the like) an adjacent portion of the upper chord 224 and/or the lower chord 226 to thereby form the joining location(s) to facilitate joining (e.g., welding) of the one or more web members 238 and the corresponding the upper chord 224 and/or the lower chord 226 at the joining locations.

Next, the plurality of welding systems 60 may move from their default retracted position to a joining position, (e.g., extend to move over a cover a predetermined associated work area, also referred to as a work envelope) over the rigging table system 10, as illustrated by FIG. 10A. The first and/or second sets of material handling systems 30 may hold or maintain the web members 238 and/or the upper chord 224 and/or the lower chord 226 in their correct position (e.g., location, orientation, pressure, or the like) while the plurality of welding systems 60 join (e.g., weld) the components or members 200 together, thereby precluding any undesirable displacement during the joining process. As such, the first and/or second sets of material handling systems 30 may apply a predetermined downward force onto the web members 238 and/or the upper chord 224 and/or the lower chord 226 in their correct position over the rigging table system 10 during the joining process. Moreover, the plurality of first welding systems 62 may join (e.g., weld) joint locations between the upper chord 224 and corresponding ends and/or bends of the web members 238, while the plurality of second welding systems 64 may simultaneously join (e.g., weld) the lower chord 226 and corresponding ends and/or bends of the web members 238 at the joining locations. The plurality of first welding systems 62 and plurality of second welding systems 64 may subsequently move back to the default retracted positions.

In some embodiments, the material handling systems 30 (e.g., same material handling systems 30 or a second set of material handling systems 30) may retract and move towards the material supply station to load a second set of web members 238’ from the material supply station, and may transport the second set of web members 238’ towards the rigging table system 10. In some embodiments, the material handling systems 30 may turn, rotate, and/or otherwise orient) the web members 238’ in accordance with the required structure of the joist, while the web members 238’ are being transported towards the rigging table system 10. Next, the material handling systems 30 position the second set of web members 238’ at the rigging table system 10 between the already positioned first upper chord 224 and first lower chord 226 and adjacent already positioned first set of web members 238. The second set of web members 238’ may also be positioned at a predetermined position, angle, spacing, and/or the like in accordance with the required structure of the joist 220. Moreover, the web members 238’ may be positioned relative to (i) the upper chord 224 and lower chord 226, and/or (ii) the first set of web members 238 such that each of the web members 238’ forms at least one joining location with the upper chord 224 and/or the lower chord 226 and/or a web member of the first set of web members 238. Here, at least a portion of each end and/or bends of each of the web members 238’ may be positioned to be proximate (e.g., contact, overlap, or the like) an adjacent portion of the upper chord 224 and/or the lower chord 226 to thereby form the joining location(s) to facilitate joining (e.g., welding) of the pair of the web member 238’ and the corresponding upper chord 224 and/or lower chord 226 at the joining position. Moreover, the second set of web members 238’ may similarly form joining locations with the first set of web members 238.

Next, the plurality of welding systems 60 may move from their default retracted position to a joining position (e.g., extend to move over a cover a predetermined associated work area, also referred to as a work envelope) over the rigging table system 10. The plurality of first welding systems 62 and plurality of second welding systems 64 may simultaneously join (e.g., weld) the second set of web members 238’ to the upper chord 224, lower chord 226, and/or the first set of web members 238. The second set of material handling systems 30 may hold or maintain the second set of web members 238’ in their correct position (e.g., location, orientation, pressure, or the like) while the plurality of welding systems 60 join (e.g., weld) the components or members 200 together, thereby precluding any undesirable displacement during the joining process. As such, the material handling systems 30 may apply a predetermined downward force onto the second set of web members 238’ in their correct position over the rigging table system 10 during the joining process.

It should be further understood that one or more sensors 1540 (e.g., image sensors – cameras, IR, or the like, accelerometers, laser sensors, position sensors, weight sensors, force sensors, or the like) may be used throughout the joist assembly system 1. The sensors may be any type of sensor that is used for various purposes, such as but not limited to checking the size and/or position of the chords 222 and/or webs 238, checking the welds on the joists 220, checking the location of the devices within the joist assembly system 1, identifying foreign objects (e.g., people, members that should not be present, or the like) in the joist assembly system 1, or the like. In some embodiments of the invention, the sensors (e.g., a web sensor system, chord sensor system, not illustrated) may be utilized to identify the web members 238, chord members 222, or the like. For example, the sensors (e.g., laser sensors, or the like) may identify the web members 238 (e.g., based on the length of the web members 238) in order to make sure the correct webs have been provided in the material supply station 40. Moreover, the sensors may identify the position of the web members 238 when loaded on the table in order to identify if they have been placed in the proper location (e.g., to adjust welding if needed). Additionally, the sensors may also detect if the chord members 222 are present and/or have been loaded properly (e.g., and stop the joist assembly system 1, if the incorrect webs members 238 or chord members 222 have been used or positioned, and/or are not present). Furthermore, sensors (e.g., lasers, or the like) may be used to locate where additional parts should be located (e.g., bracing clips, spacers, or the like) that may be assembled manually. Should the sensors identify a potential issue with any of the foregoing, an alert may be sent to a user, the operation of the joist assembly system 1 (or particular device thereof) may be adjusted (e.g., stopped or slowed down). Furthermore, it should be understood that the welding parameters (e.g., time, filler used, route of the welding tip, temperature, or the like may be monitored for each of the welding systems 60) in order to capture data about the welding process for each joist, which may allow the controller 1550 to determine if there are any anomalies that occurred in the welding process.

Computer systems (e.g., user computer systems 1520) may be provided within, upstream, and/or downstream of the joist assembly system 1 in order to provide operating information to the users. The information displayed may include any alerts identified by the controller 1550 in the joist assembly system 1, that may require a user to take an action with respect to a joist 220 and/or the joist assembly system 1. For example, graphical user interfaces may illustrate to users if there are any potential errors in the welds that may require inspection and/or repair after the joist 220 has been discharged from the joist assembly system 1.

In other embodiments of the invention, the welding systems 60 may be replaced or supplemented by other methods of the joining the webs members 238 to the chord members 222. For example, fasteners may be used in order to join the web members 238 to the chord members 222. As such, other joining systems may be implemented should other types of joining of the web members 238 and chord members 222 be utilized.

In some embodiments, when the upper chord and/or lower chord have multiple portions, after welding of the web members 238 to the first portions, the first set of material handling systems 30 may load (e.g., retrieve, transport, position, or the like) a second upper chord 224’ and a second lower chord 226’ from the material supply station, and may then position the retrieved second upper chord 224’ and second lower chord 226’ at the rigging table system 10. As such, the second upper chord 224’ may be positioned over the existing first upper chord 224 and the second lower chord 226’ may be positioned over the existing lower chord 226 at the rigging table system 10, with the second upper chord 224’ and the second lower chord 226’ being spaced apart by a predetermined distance. The second upper chord 224’ may be held in place and supported by the plurality of upper chord projections 14a in conjunction with the plurality of upper chord cavities 16a, while the second lower chord 226’ maybe held in place and supported by the plurality of lower chord projections 14b in conjunction with the plurality of lower chord cavities 16b, similar to the manner described previously with respect to the first upper and lower chords (224, 226). Additionally, or alternatively, the first set of material handling systems 30 may continue to hold the second upper and lower chords 224’ in place by applying a predetermined amount of downward force.

Next, the plurality of welding systems 60 may move from their default retracted position to a joining position (e.g., extend to move over a cover a predetermined associated work area, also referred to as a work envelope) over the rigging table system 10. The plurality of first welding systems 62 and plurality of second welding systems 64 may simultaneously join (e.g., weld) the second upper chord 224’ and the second lower chord 226’ to the upper chord 224, lower chord 226, the first set of web members 238, the second set of web members 238’, spacers, and/or a third set of web members, to thereby form the joist 220. The plurality of welding systems 60 may then move to the default retracted position and/or to a maintenance position.

The discharge process of the constructed joist 220 from the rigging table system 10 will now be described in further detail. In some embodiments of the invention, the discharging system 50 may comprise a plurality of rollers 52. As illustrated by the detail view in FIGS. 10A-10B, during or immediately upon assembly of the joist 220, the plurality of rollers 52 of the discharging system 50 may be in a retracted position. Next, the plurality of rollers 52 may extend upwards (e.g., out of cavities of the rigging table system 10 in which the joist 220 rests. In this way, the extending or extended plurality of rollers 52 may cause the joist 220 to be released from the plurality of upper chord projections 14a and plurality of lower chord projections 14b and lift the joist 220 at least partially above the rigging table system 10. Next, rotation of the plurality of rollers 52 may be activated which causes linear displacement or discharge of the joist 220 out of the rigging table system 10. The discharged joist 220 may then be lifted and transported to the desired location. The process may be repeated to form additional joists 220.

### Controller Systems

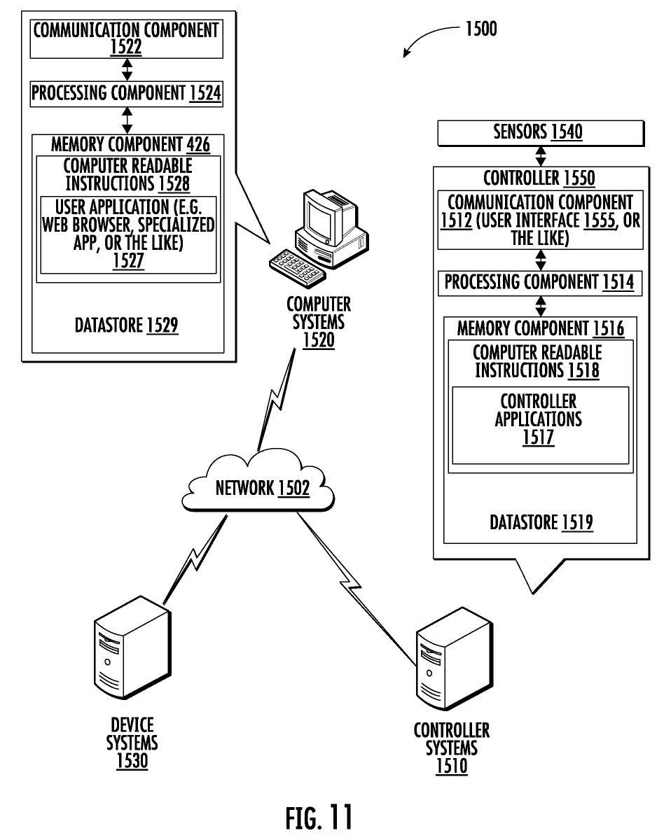

The operation of the joist assembly system 1, including the plurality of material handling systems 30, a plurality of welding systems 60, the material supply stations 40 (e.g., including the chord and/or web supply systems), the rigging table system 10, and/or the like, and the devices (e.g., robots, carriages, actuators, weld feeders, weld tip cleaners, or the like), are controlled by a programmable controller 1550, which may communicate with other systems within or outside of a facility. As such, FIG. 11 illustrates a joist assembly network system 1500, in accordance with embodiments of the present disclosure. As illustrated in FIG. 11, one or more controller systems 1510 are coupled, via a network 1502, to one or more user computer systems 1520, one or more device systems 1530 (e.g., systems that control the robots, carriages, actuators, weld feeders, weld tip cleaners, or the like of the joist assembly system 1), and/or one or more other systems (not illustrated). In this way, the controller systems 1510 operating the joist assembly system 1 may communicate with one or more device systems 1530 for assembling the joists as described herein. The controller systems 1510 may communicate with user computer systems 420 to allow the users of the user computer systems 1520 to monitor the joist assembly system 1. Moreover, the controller systems 1510 may communicate with other systems, such as other systems of other machinery in the facility and/or other systems outside of the facility (e.g., ordering systems, third party systems, or the like) to determine what chords 222 and/or webs 238 need to be provided to joist assembly system 1. The communications may occur over a network 1502, as will be described in further detail herein.

The network 1502 may be a global area network (GAN), such as the Internet, a wide area network (WAN), a local area network (LAN), or any other type of network or combination of networks. The network 1502 may provide for wireline, wireless, or a combination of wireline and wireless communication between systems, services, components, and/or devices on the network 1502.

As illustrated in FIG. 11, the one or more controller systems 1510 may comprise a controller 1550 that may generally comprise one or more communication components 1512, one or more processing components 1514, and one or more memory components 1516. The one or more processing components 1514 are coupled to the one or more communication components 1512, and the one or more memory components 1516. As used herein, the term “processing component” generally includes circuitry used for implementing the communication and/or logic functions of a particular system. For example, a processing component may include a digital signal processor component, a microprocessor component, and various analog-to-digital converters, digital-to-analog converters, and other support circuits and/or combinations of the foregoing. Control and signal processing functions of the system are allocated between these processing components according to their respective capabilities. The one or more processing components may include functionality to operate one or more software programs based on computer-readable instructions thereof, which may be stored in the one or more memory components.

The controller 1550 components, such as the one or more communication components 1512, may be coupled to the one or more sensors 1540 (e.g., safety sensors, supply sensors, location sensors, laser sensors, or the like) as previously discussed herein) located within the joist assembly system 1.

The one or more processing components 1514 use the one or more communication components 1512 to communicate with the network 1502 and other components on the network 1502, such as, but not limited to, the components of the one or more user computer systems 1520, the one or more device systems 1530, and/or the one or more other systems (not illustrated). As such, the one or more communication components 1512 generally comprise a wireless transceiver, modem, server, electrical connection, electrical circuit, or other component for communicating with other components on the network 1502. The one or more communication components 1512 may further include an interface that accepts one or more network interface cards, ports for connection of network components, Universal Serial Bus (USB) connectors, or the like. Moreover, the one or more communication components 1512 may include a keypad, keyboard, touch-screen, touchpad, microphone, mouse, joystick, other pointer component, button, soft key, and/or other input/output component(s) for communicating with the users. In some embodiments, as described herein the one or more communication components 1512 may comprise a user interface, such as a graphical user interface 1555 that allows a user to control and/or monitor the operation of the joist assembly system 1.

As further illustrated in FIG. 11, the one or more controller systems 1510 comprise computer-readable instructions 1518 stored in the one or more memory components 1516, which in some embodiments includes the computer-readable instructions 1518 of the one or more controller applications 1517 (e.g., used to operate the joist assembly system 1 and/or the devices thereof, or the like). In some embodiments, the one or more memory components 1516 include one or more data stores 1519 for storing data related to the joist assembly system 1, including, but not limited to, data created, accessed, and/or used by the one or more controller systems 1510 to operate the one or more joist assembly systems 1 in order to form the joists (e.g., in accordance with joist specifications that may be stored, or the like). In some embodiments, the controller systems 1510 may utilize machine learning and/or artificial intelligence to aid in assembling the joists 220.

As illustrated in FIG. 11, users may communicate with each other over the network 1502 and the controller systems 1510, the device systems 1530, and/or other systems in order to control and/or monitor the various systems at the joist assembly system 1 and/or remotely. Consequently, the one or more users may be assemblers, welders, employees, agents, representatives, officers, or the like of an organization operating the facility. The one or more user computer systems 1520 may be a desktop, laptop, tablet, mobile device (e.g., smartphone device, or other mobile device), or any other type of computer that generally comprises one or more communication components 1522, one or more processing components 1524, and one or more memory components 1526. In some embodiments the one or more computer systems 1520 may be located upstream or downstream of the joist assembly system 1 and are used for pre-assembly and/or pre-inspections of the chords 222 and/or webs 238 (e.g., assembly of the bracing clips and/or spacers, or the like), and/or post assembly and/or post-inspection of the joists 220 (e.g., complete the welding, inspect welding, and/or the like).

The one or more processing components 1524 are coupled to the one or more communication components 1522, and the one or more memory components 1526. The one or more processing components 1524 use the one or more communication components 1522 to communicate with the network 1502 and other components on the network 1502, such as, but not limited to, the one or more controller systems 1510, the one or more device systems 1530, and/or the other systems (not illustrated). As such, the one or more communication components 1522 generally comprise a wireless transceiver, modem, server, electrical connection, or other component for communicating with other components on the network 1502. The one or more communication components 1522 may further include an interface that accepts one or more network interface cards, ports for connection of network components, Universal Serial Bus (USB) connectors and the like. Moreover, the one or more communication components 1522 may include a keypad, keyboard, touch-screen, touchpad, microphone, mouse, joystick, other pointer component, button, soft key, and/or other input/output component(s) for communicating with the users. In some embodiments, the one or more communication components 1522 may comprise a user interface, such as a graphical user interface that allows a user to remotely control and/or monitor the operation of the joist assembly system 1.

As illustrated in FIG. 11, the one or more user computer systems 1520 may have computer-readable instructions 1528 stored in the one or more memory components 1526, which in some embodiments includes the computer-readable instructions 1528 for user applications 1527, such as dedicated applications (e.g., apps, progressive web apps, or the like), portions of dedicated applications, a web browser or other apps that allow access to applications located on other systems, or the like. In some embodiments, the one or more memory components 1526 include one or more data stores 1529 for storing data related to the one or more user computer systems 1520, including, but not limited to, data created, accessed, and/or used by the one or more user computer systems 1520. The user application 1527 may use the applications of the one or more controller systems 1510, the one or more product systems 1530, and/or one or more other systems (not illustrated) in order to communicate with other systems on the network 1502 and take various actions described herein (e.g., operation, use, monitoring, or the like the joist assembly system 1).

Moreover, as illustrated in FIG. 11, the one or more device systems 1530 and/or other systems (not illustrated) have components the same as or similar to the components described with respect to the one or more controller systems 1510 and the one or more user computer systems 1520 (e.g., one or more communication components, one or more processing components, one or more sensors, one or more memory devices with computer-readable instructions of one or more product applications, one or more datastores, or the like). Thus, the one or more device systems 1530 communicate with the one or more controller systems 1510, the one or more user computer systems 1520, and/or one or more other systems in the same or similar way as previously described with respect to the one or more controller systems 1510, the one or more user computer systems 1520, and/or the one or more other systems. The one or more device systems 1530 may comprise the systems that operate the machines (e.g., robots, carriages, rollers, actuators, or the like) of the joist assembly system 1 that are used to assemble the joists 220.

### Process of Forming a Joist

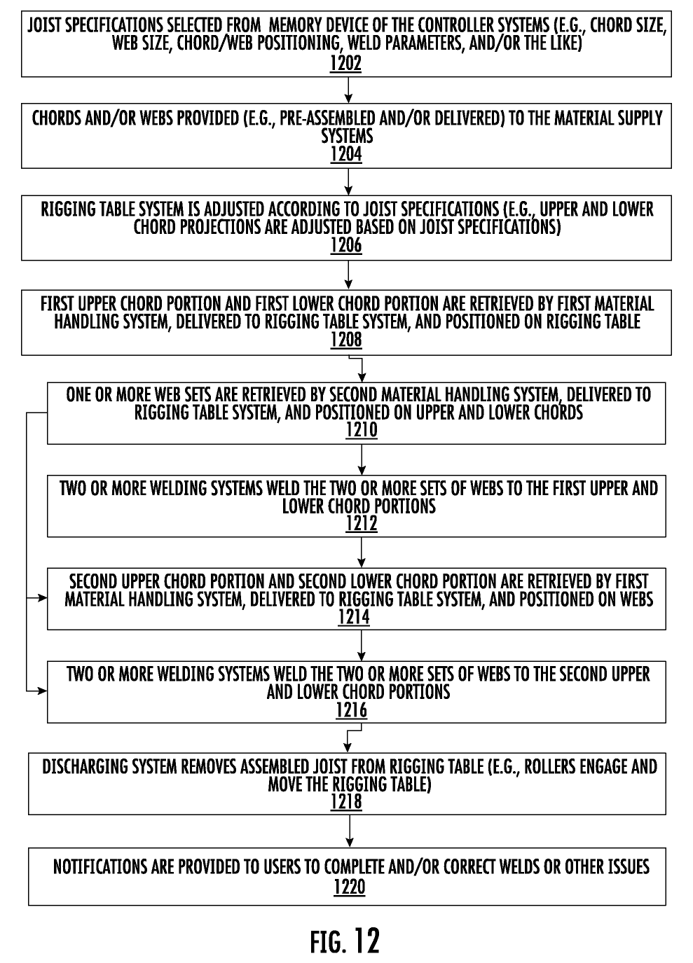

FIG. 12 illustrates a process flow for assembling a joist 220 using the joist assembly system 1 described herein. As illustrated by block 1202, the specifications for a joist are selected. The specifications may be stored in the controller systems 1510. For example, a user may store specifications for different types of joists 220, and a user may select one joist of the plurality of joists for assembly, or otherwise may select one or more specifications in order to determine the joist 220 to be assembled. The controller 1550 uses the specifications in order to determine how to operate the joist assembly system 1 for assembling the joist 220 selected.

Block 1204 of FIG. 12 further illustrates that the chords 222 and/or webs 238 are provided to the supply systems 300 (e.g., webs supply system 302, chord supply system 304, or the like). The chords 222 and/or webs 238 may have bracing clips, spacers, and/or other components pre-assembled before, during, or after delivery to the supply systems 300. The supply systems 300 deliver the chords 222 and/or webs 238 to the material supply station. As previously discussed herein, the material supply station may be located at least partially above the rigging table system 10 (e.g., as part of the overhead transport system 130). In some embodiments, the chords 222 and/or webs 238 may already be located in the material supply station when the user makes the selection of a specification for a joist 220.

Block 1206 illustrates that the rigging table system 10 may be adjusted based on the type of joist 220 being assembled (e.g., the projections of the rigging table may be adjusted farther apart or closer together for receipt of the first upper and lower chords). The adjustment may occur manually and/or automatically through the use of the controller 1550 or other system.

FIG. 12 further illustrates in block 1208 that the material handling systems 30 (e.g., a first group of material handling systems 30) pick a first upper chord portion 224a and a first lower chord portion 226a and deliver it to the rigging table system 10. The first group of material handling systems 30 place the chord portions 224a, 226a within the chord projections 14 in order to hold the first chord portions 224a, 226a in place, and may continue to hold the chord portions 224a, 226a using a predetermined amount of downward force as previously discussed. In other embodiments, when the upper chord 224 and lower chord 226 are made of a single portion, the material handling systems 30 may be pick the upper chord 224 and/or lower chord 226. Alternatively, as previously described herein, the upper chord 224 and/or lower chord 226 may be delivered to an end of the rigging table system 10 using other material supply systems 10 that may or may not utilize the material handling 30 (e.g., the overhead transport system 130, or the like).

Block 1210 of FIG. 12 illustrates that the material handling systems 30 (e.g., same set or a second set of material handling systems 30) pick one or more sets of webs 238 (e.g., vertical, diagonal, or the like) from the material supply station 40 and deliver the one or more sets of webs 238 to the rigging table 10. For example, the material handling systems 30 may hold the webs 238 in the desired position on the first upper and lower chord portions 224a, 226a for welding, and may use a predetermined amount of downward force as previously discussed.

FIG. 12 illustrates in block 1212 that the two or more welding systems 60 weld the one or more sets of webs 238 (e.g., vertical, diagonal, or the like) to the first upper and lower chord portions 224a, 226a. Specifically, each of the two or more welding systems 60 may weld one or more sets of webs 238, such that the two or more sets of webs 238 are welded simultaneously to the chord portions 224a, 226a. In some embodiments, the welding starts as the first and second material handling systems 30 hold the webs 238, which may be retracted as the welding is completed, or may continue to hold the webs 238 in place. However, in some embodiments, the system may bypass block 1212 and proceed directly to block 1214, or bypass blocks 1212 and 1214 and proceed to block 1216.

When the upper chord 224 and lower cord 226 comprise of multiple portions, block 1214 of FIG. 12 further illustrates that the material handling systems 30 (e.g., a first set of material handling systems) pick a second upper chord portion 224b and a second lower chord portion 226b from the material supply station 40 and deliver them to the rigging table 10, such as over the webs 238 and/or spacers of the first upper and lower chords 224a, 226a. In some embodiments, the first group of material handling systems 30 continue to hold the first upper and lower chords 224a, 226a in place, and a third group of material handling system 30 may complete the step illustrated in block 1214.

FIG. 12 further illustrates in block 1216 that in some embodiments the two or more welding systems 60 weld (e.g., tact weld or completely weld) the first upper chord portion 224b and the second lower chord portion 226b to the webs 238 and/or spacers of the first upper and lower chord portions 224a, 226a. Specifically, each of the two or more welding systems 60 may weld one or more sets of webs 238, such that the two or more sets of webs 238 are welded simultaneously to the chord portions 224b, 226b. In embodiments where the system proceeds directly from block 1210 to 1214, and/or to 1216, the two or more welding systems may, at block 1216, weld the one or more sets of webs 238 to both the first upper and lower chord portions 224a, 226a and second upper and lower chord portions 224b, 226b simultaneously, or to the upper and lower chords 224, 226 made of a single chord portion.

Block 1218 further illustrates in FIG. 12 that the joist 220 is discharged from the rigging table and moved downstream of the rigging table system 10. For example, the rollers of the rigging table system 10 may be engaged (e.g., raised, or the like), which lifts the joist 220 out of the projections on the rigging table system 10. The rollers may then be activated to roll the joist 220 downstream off of the rigging table system 10. However, it should be understood that systems in addition to, or other than, rollers 52 may be used to discharge the joists 220 from the rigging table system 10 (e.g., arm that lifts, overhead track, or the like). In some embodiments users located downstream of the rigging table system 10 may complete the welds between the second upper and lower chord portions 224b, 226b and the webs 238 and/or the spacers of the first upper and lower chord portions 224a, 226a. In some embodiments, some locations of the joists 220 may be difficult to access using the welding systems 60, as such, some hand welding may be performed.

FIG. 12 further illustrates in block 1220 that notifications may be provided to users downstream on the user computer systems 1520. The notifications may be alerts related to the assembly of the joist 220, such as potential welds that need to be checked and/or corrected. Other notifications may include locations where apertures may need to be formed into the joists 220 (alternatively, the apertures may be pre-formed in the chords 222 and/or webs 238 before being assembled), additional components that need to be added to joists 220 (e.g., bracing clips), joist seats that need to be added to the joists 220, or the like.

The joist assembly system 1 described herein provides improvements to conventional rigging tables that require users to physically pick up the members, lift them over their heads, turn around, and/or otherwise perform a physical operation that could cause harm to the workers, other workers, or otherwise interrupt the process of assembling joists on the rigging table. Moreover, the one or more overhead transport system 130 and/or the one or more lower transport systems 180 may allow for the reduction in the number of material handling systems 30 and/or the welding systems 60 needed to assemble the joists 220 (e.g., when compared to systems that use static material handling systems and/or welding systems). Moreover, the joist assembly system 1 of the present disclosure allows for the assembly of single or multiple joists 220 at the same time regardless of size and weight of the joists 222, including long span joists with an assembly time of 1, 2, 3, 4, 5, 6, 7, 8, 9, 10, or the like minutes (or range between, overlap, or fall outside of these values). With respect to long-span joists 220, these joists may have lengths that span from 70 to 110 feet long, and in some cases up to 220 feet long (e.g., range between, overlap, or fall outside of 70, 75, 80, 85, 90, 95, 100, 105, 110, 115, 120, 130, 140, 150, 160, 170, 180, 190, 200, 210, 220, 230, 240, or the like values). Moreover, the long span joists may have depths (e.g., heights) that vary from 50 to 120 inches (e.g., range between, overlap, or fall outside of 50, 52, 55, 60, 65, 70, 75, 80, 85, 90, 95, 100, 105, 110, 115, 120, or the like inches). Furthermore, the long span joists may weigh between 5 to 50 to 100 plf (e.g., range between, overlap, or fall outside of 5, 10, 15, 20, 25, 30, 35, 40, 45, 50, 55, 60, 65, 70, 75, or the like plf). Consequently, the joist assembly system 1 described herein may be able to assemble joists 220 more efficiently, with less cost (e.g., less robots), with less variation, at an increased rate, or the like when compared to conventional rigging tables and/or systems.

As will be appreciated by one of skill in the art in view of this disclosure, embodiments of the invention may be embodied as an apparatus, a system, computer program product, and/or other device, a method, or a combination of the foregoing. Accordingly, embodiments of the invention may take the form of an entirely hardware embodiment, an entirely software embodiment (including firmware, resident software, micro-code, etc.), or an embodiment combining software and hardware aspects that may generally be referred to herein as a system. Furthermore, embodiments of the invention may take the form of a computer program product comprising a computer-usable storage medium having computer-usable program code/computer-readable instructions embodied in the medium (e.g., a non-transitory medium, or the like).

Any suitable computer-usable or computer-readable medium may be utilized. The computer usable or computer readable medium may be, for example but not limited to, an electronic, magnetic, optical, electromagnetic, infrared, or semiconductor system, apparatus, or device. More specific examples (a non-exhaustive list) of the computer-readable medium would include the following: an electrical connection having one or more wires; a tangible medium such as a portable computer diskette, a hard disk, a random access memory (RAM), a read-only memory (ROM), an erasable programmable read-only memory (EPROM or Flash memory), a compact disc read-only memory (CD-ROM), or other tangible optical or magnetic storage device.

Computer program code/computer-readable instructions for carrying out operations of embodiments of the invention may be written in an object oriented, scripted or unscripted programming language such as Java, Pearl, Python, Smalltalk, C++ or the like. However, the computer program code/computer-readable instructions for carrying out operations of the invention may also be written in conventional procedural programming languages, such as the “C” programming language or similar programming languages.

As described herein, when discussing the movement of the members, components and the like as being vertical, horizontal, etc., it is understood that the movements in the vertical direction or horizontal direction may not be exactly vertical or horizontal, such that the term substantially or generally vertical or horizontal includes movements and/or components that are exactly vertical or horizontal, or out of the exact vertical or horizontal plane.

It should be understood that “coupled,” when used herein, means that the components, devices, members, or the like may be formed integrally with each other, or may be formed separately and coupled together. Furthermore, “coupled” means that the components may be formed directly to each other, or to each other with one or more components located between the components that are coupled together. Furthermore, “coupled” may mean that the components are detachable from each other, or that they are permanently coupled together

Specific embodiments of the invention are described herein. Many modifications and other embodiments of the invention set forth herein will come to mind to one skilled in the art to which the invention pertains, having the benefit of the teachings presented in the foregoing descriptions and the associated drawings. Therefore, it is to be understood that the invention is not to be limited to the specific embodiments disclosed and that modifications and other embodiments and combinations of embodiments are intended to be included within the scope of the appended claims. Although specific terms are employed herein, they are used in a generic and descriptive sense only and not for purposes of limitation.

What is claimed is:

1. A joist assembly system, comprising:
a support structure;
a plurality of material handling systems configured move one or more chords or one or more webs of a joist;
a plurality of welding systems configured to weld the one or more webs to the one or more chords;
a rigging table system configured to support at least a portion of the joists during assembly;
an overhead transport system coupled to the support structure, wherein the plurality of material handling systems or the plurality of welding systems are coupled to the overhead transport system at least partially above the rigging table system, and wherein the overhead transport system transports the plurality of material handling systems or the plurality of welding systems longitudinally and laterally with respect to the rigging table system; and
a controller system comprising:
one or more memory components storing computer-readable code; and
one or more processing components coupled to the one or more memory components, wherein when executed the computer-readable code is configured to cause the one or more processing components to:
communicate with the plurality of material handling systems to position the one or more webs with respect to the one or more chords; and
communicate with the plurality of welding systems to weld the one or more webs to the one or more chords.

2. The joist assembly system of claim 1, wherein the overhead transport system comprises:
one or more upper transport assemblies comprising:
one or more upper longitudinal tracks;
one or more upper longitudinal carriages coupled to the one or more upper longitudinal tracks; and
one or more upper longitudinal drives configured to move the one or more upper longitudinal carriages with respect to the one or more upper longitudinal tracks;
wherein the one or more upper longitudinal carriages move with respect to the one or more upper longitudinal tracks.

3. The joist assembly system of claim 2, wherein the one or more upper transport assemblies comprise:
one or more upper lateral tracks coupled to the one or more upper longitudinal carriages;
one or more upper lateral carriages coupled to the one or more upper lateral tracks; and
one or more upper lateral drives configured to move the one or more upper lateral carriages with respect to the upper lateral tracks.

4. The joist assembly system of claim 1, wherein the plurality of material handling systems are coupled to the overhead transport system.

5. The joist assembly system of claim 1, wherein the plurality of welding systems are coupled to the overhead transport system.

6. The joist assembly system of claim 1, wherein two or more of the plurality of material handling system or two or more of the plurality of welding systems are coupled to the overhead transport system.

7. The joist assembly system of claim 1, further comprising:
a lower transport system, wherein the lower transport system comprises:
one or more lower transport assemblies comprising:
one or more lower tracks;
one or more lower carriages coupled to the one or more lower tracks; and
one or more lower drives configured to move the one or more lower carriages with respect to the one or more lower tracks;
wherein the one or more lower carriages move with respect to the one or more lower tracks;
wherein the other of the plurality of material handling system or the plurality of welding systems are coupled to the lower transport system adjacent the rigging table system.

8. The joist assembly system of claim 1, wherein the support structure comprises:
an overhead support located above the rigging table system.

9. The joist assembly system of claim 8, wherein the overhead support comprises:
one or more vertical supports extending from a floor adjacent the rigging table system to a height above the rigging table system, wherein the overhead transport system is coupled to an upper portion of the one or more vertical supports.

10. The joist assembly system of claim 8, wherein the overhead support comprises:
one or more ceiling supports coupled to one or more building supports, wherein the overhead transport system is coupled to the one or more ceiling supports.

11. The joist assembly system of claim 1, wherein the plurality of material handling systems comprise:
a plurality of web material handling systems coupled to the overhead transport system;
wherein the plurality of web material handling systems are configured to pick the one or more webs; and
wherein the plurality of web material handling systems are configured to hold the one or more webs in place to restrict movement of the one or more webs while the plurality of welding systems at least partially weld the one or more webs to the one or more chords.

12. The joist assembly system of claim 1, wherein the plurality of material handling systems comprise a material handling robotic arm and a material handling effector.

13. The joist assembly system of claim 1, wherein the plurality of welding systems comprise:
a plurality of first welding systems adjacent a first side of the rigging table system, wherein the plurality of first welding systems are configured to weld the one or more webs to an upper chord; and
a plurality of second welding systems adjacent a second side of the rigging table system, wherein the plurality of second welding systems are configured to weld the one or more webs to a lower chord.

14. The joist assembly system of claim 1, wherein the plurality of welding systems comprise a welding robotic arm and a weld head.

15. The joist assembly system of claim 1, further comprising:
a material supply station, wherein the material supply station comprises a chord supply system configured to supply the one or more chords to an entry end of the rigging table system.

16. The joist assembly system of claim 1, wherein the rigging table system comprises:
a discharging system configured to move an assembled joist away from the rigging table system.

17. The joist assembly system of claim 16, wherein the discharging system comprises:
a plurality of rollers, wherein the plurality of rollers are configured to extend from a rigging table and retract within the rigging table, wherein the plurality of rollers rotate, and wherein the discharging system is configured to discharge an assembled joist such that the plurality of rollers are extended to disengage the assembled joist from the rigging table system and the plurality of rollers rotate to move the assembled joist off of the rigging table system.

18. The joist assembly system of claim 1, wherein the one or more chords comprise an upper chord comprising a first upper chord portion and a second upper cord portion, and a lower chord comprising a first lower chord portion and a second lower chord portion, and wherein the computer-readable code is configured to cause the one or more processing components to:
communicate with one or more material handling systems of the plurality of material handling systems to pick the first upper chord portion and the first lower chord portion from a material supply station and position the first upper chord portion and the first lower chord portion on the rigging table system, and wherein two or more welding systems weld the one or more webs to the first upper chord portion and the first lower chord portion at the same time; and
communicate with the one or more material handling systems of the plurality of material handling systems to pick a second upper chord portion and a second lower chord portion from the material supply station and position the second upper chord portion and the second lower chord portion onto the one or more webs, and wherein the two or more welding systems weld the second upper chord portion and the second lower chord portion to the one or more webs at the same time.

19. A method of assembling a joist using the joist assembly system of claim 1, the method comprising:
positioning the one or more chords at the rigging table system;
picking the one or more webs using one or more of the plurality of material handling systems;
positioning the one or more webs with respect to the one or more chords at the rigging table system; and
welding the one or more webs to the one or more chords.
